(19) United States
(12) Patent Application Publication
(10) Pub. No.: US 2024/0322964 A1
(43) Pub. Date: Sep. 26, 2024

(54) TECHNIQUES FOR INCREASED QUANTITIES OF ORTHOGONAL DMRS PORTS

(71) Applicant: QUALCOMM Incorporated, San Diego, CA (US)

(72) Inventors: Pinar SEN, San Diego, CA (US); Muhammad Sayed Khairy ABDELGHAFFAR, San Jose, CA (US); Yu ZHANG, San Diego, CA (US); Yi HUANG, San Diego, CA (US)

(21) Appl. No.: 18/575,509

(22) PCT Filed: Aug. 30, 2021
(86) PCT No.: PCT/CN2021/115250

§ 371 Date: Dec. 29, 2023

(51) Int. Cl. H04L 5/00; H04W 72/04

(52) U.S. Cl. CPC H04L 5/0048; H04W 72/04

(57) ABSTRACT

Methods, systems, and devices for wireless communications are described. A user equipment may be configured to receive, from a base station, first control signaling indicating a first frequency domain orthogonal cover code (FD-OCC) sequence length of a set of FD-OCC sequence lengths associated with wireless communications with the base station. The UE may receive, from the base station, second control signaling including an indication of a first antenna port value of a set of antenna port values for wireless communications between the UE and the base station. The UE may transmit, to the base station, at least one demodulation reference signal (DMRS) via at least one antenna port of a set of orthogonal antenna ports identified based at least in part on the first FD-OCC sequence length and the first antenna port value.

### CROSS REFERENCE

The present Application is a 371 national stage filing of International PCT Application No. PCT/CN2021/115250 by SEN et al. entitled “TECHNIQUES FOR INCREASED QUANTITIES OF ORTHOGONAL DMRS PORTS,” filed Aug. 30, 2021, which is assigned to the assignee hereof, and which is expressly incorporated by reference in its entirety herein.

### FIELD OF TECHNOLOGY

The present disclosure relates to wireless communications, including techniques for increased quantities of orthogonal demodulation reference signal (DMRS) ports.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support techniques for increased quantities of orthogonal demodulation reference signal (DMRS) ports. Generally, aspects of the present disclosure support techniques for increasing a sequence length of frequency domain orthogonal cover codes (FD-OCCs) supported by a wireless communications system, thereby increasing a quantity of available orthogonal DMRS ports for supporting a higher number of spatial layers for uplink transmissions. In particular, techniques described herein are directed to techniques for signaling higher-order FD-OCCs (e.g., having a sequence length N>2), and configurations for indicating antenna port values for higher-quantities of supported DMRS ports. For example, a user equipment (UE) may receive control signaling which indicates an FD-OCC sequence length value for wireless communications with the network. The FD-OCC sequence length value may be 4, 6, 8, etc. (e.g., N=4, 6, 8). The UE may then receive an indication of an antenna port value, and may determine which one or more orthogonal DMRS ports are to be used for transmitting DMRSs based on the indicated FD-OCC sequence length value and the antenna port value.

A method for wireless communication at a UE is described. The method may include receiving, from a base station, first control signaling indicating a first FD-OCC sequence length of a set of multiple FD-OCC sequence lengths associated with wireless communications with the base station, receiving, from the base station, second control signaling including an indication of a first antenna port value of a set of multiple antenna port values for wireless communications between the UE and the base station, and transmitting, to the base station, at least one DMRS via at least one antenna port of a set of multiple orthogonal antenna ports identified based on the first FD-OCC sequence length and the first antenna port value.

An apparatus for wireless communication at a UE is described. The apparatus may include a processor, memory coupled with the processor, and instructions stored in the memory. The instructions may be executable by the processor to cause the apparatus to receive, from a base station, first control signaling indicating a first FD-OCC sequence length of a set of multiple FD-OCC sequence lengths associated with wireless communications with the base station, receive, from the base station, second control signaling including an indication of a first antenna port value of a set of multiple antenna port values for wireless communications between the UE and the base station, and transmit, to the base station, at least one DMRS via at least one antenna port of a set of multiple orthogonal antenna ports identified based on the first FD-OCC sequence length and the first antenna port value.

Another apparatus for wireless communication at a UE is described. The apparatus may include means for receiving, from a base station, first control signaling indicating a first FD-OCC sequence length of a set of multiple FD-OCC sequence lengths associated with wireless communications with the base station, means for receiving, from the base station, second control signaling including an indication of a first antenna port value of a set of multiple antenna port values for wireless communications between the UE and the base station, and means for transmitting, to the base station, at least one DMRS via at least one antenna port of a set of multiple orthogonal antenna ports identified based on the first FD-OCC sequence length and the first antenna port value.

A non-transitory computer-readable medium storing code for wireless communication at a UE is described. The code may include instructions executable by a processor to receive, from a base station, first control signaling indicating a first FD-OCC sequence length of a set of multiple FD-OCC sequence lengths associated with wireless communications with the base station, receive, from the base station, second control signaling including an indication of a first antenna port value of a set of multiple antenna port values for wireless communications between the UE and the base station, and transmit, to the base station, at least one DMRS via at least one antenna port of a set of multiple orthogonal antenna ports identified based on the first FD-OCC sequence length and the first antenna port value.

Some examples of the method, apparatuses, and non-transitory computer-readable medium described herein may further include operations, features, means, or instructions for receiving, via the second control signaling, one or more antenna port field values including the indication of the first antenna port value, the first antenna port value associated with a subset of antenna ports of the set of multiple antenna ports, the subset of antenna ports including the at least one antenna port and receiving, from the base station based on the one or more antenna port field values, an indication of the at least one antenna port included within the subset of antenna ports, where transmitting the at least one DMRS may be based on the indication of the at least one antenna port.

Some examples of the method, apparatuses, and non-transitory computer-readable medium described herein may further include operations, features, means, or instructions for receiving the indication of the at least one antenna port of the subset of antenna ports via the first control signaling, third control signaling, or both.

Some examples of the method, apparatuses, and non-transitory computer-readable medium described herein may further include operations, features, means, or instructions for receiving the indication of the at least one antenna port of the subset of antenna ports via one or more additional field values included within the second control signaling.

In some examples of the method, apparatuses, and non-transitory computer-readable medium described herein, the one or more additional field values include a TDRA field value, a FDRA field value, a SRS CS field value, or any combination thereof.

Some examples of the method, apparatuses, and non-transitory computer-readable medium described herein may further include operations, features, means, or instructions for receiving, via the second control signaling, a set of multiple antenna port field values including the indication of the first antenna port value, the set of multiple antenna port field values including four or more antenna port field values.

Some examples of the method, apparatuses, and non-transitory computer-readable medium described herein may further include operations, features, means, or instructions for receiving, via the first control signaling or additional control signaling, an activation of at least one antenna port field value of the set of multiple antenna port field values, where receiving the indication of the first antenna port value may be based on the activation of the at least one antenna port field value.

Some examples of the method, apparatuses, and non-transitory computer-readable medium described herein may further include operations, features, means, or instructions for receiving, via the first control signaling, the second control signaling, additional control signaling, or any combination thereof, an indication of a rank associated with wireless communications between the UE and the base station, receiving, via the second control signaling, a set of multiple antenna port field values including the indication of the first antenna port value, and identifying the at least one antenna port based on the set of multiple antenna port field values and the rank.

Some examples of the method, apparatuses, and non-transitory computer-readable medium described herein may further include operations, features, means, or instructions for identifying one or more additional antenna ports of the set of multiple antenna ports based on the set of multiple antenna port field values and the rank, where transmitting the at least one DMRS may be based on the one or more additional antenna ports.

Some examples of the method, apparatuses, and non-transitory computer-readable medium described herein may further include operations, features, means, or instructions for identifying a set of CS values, a Walsh sequence, or both, associated with wireless communications between the UE and the base station based on the indication of the first antenna port value and identifying the at least one antenna port of the set of multiple antenna ports in accordance with the set of CS values, the Walsh sequence, or both.

Some examples of the method, apparatuses, and non-transitory computer-readable medium described herein may further include operations, features, means, or instructions for receiving, from the base station, third control signaling indicating a second FD-OCC sequence length of the set of multiple FD-OCC sequence lengths associated with wireless communications with the base station, the second FD-OCC sequence length different from the first FD-OCC sequence length, receiving, from the base station, fourth control signaling including an indication of a second antenna port value of the set of multiple antenna port values for wireless communications between the UE and the base station, and transmitting, to the base station, at least one additional DMRS via at least one additional antenna port of the set of multiple orthogonal antenna ports identified based on the second FD-OCC sequence length and the second antenna port value.

Some examples of the method, apparatuses, and non-transitory computer-readable medium described herein may further include operations, features, means, or instructions for transmitting, to the base station, an indication of a channel quality associated with a channel between the UE and the base station, where receiving the third control signaling, receiving the fourth control signaling, or both, may be based at least in a part on transmitting the indication of the channel quality.

In some examples of the method, apparatuses, and non-transitory computer-readable medium described herein, the first FD-OCC sequence length may be greater than two.

In some examples of the method, apparatuses, and non-transitory computer-readable medium described herein, the first FD-OCC sequence length may be based on an SCS associated with wireless communications between the UE and the base station, a quantity of frequency combs associated with wireless communications between the UE and the base station, or both.

In some examples of the method, apparatuses, and non-transitory computer-readable medium described herein, the first control signaling includes a radio resource control (RRC) message, a medium access control-control element (MAC-CE) message, or both, and the second control signaling includes a downlink control information (DCI) message.

In some examples of the method, apparatuses, and non-transitory computer-readable medium described herein, a first subset of the set of multiple orthogonal antenna ports may be orthogonal to a second subset of the set of multiple orthogonal antenna ports.

A method for wireless communication at a base station is described. The method may include transmitting, to a UE, first control signaling indicating a first FD-OCC sequence length of a set of multiple FD-OCC sequence lengths associated with wireless communications with the base station, transmitting, to the UE, second control signaling including an indication of a first antenna port value of a set of multiple antenna port values for wireless communications between the UE and the base station, and receiving, from the base station, at least one DMRS via at least one antenna port of a set of multiple orthogonal antenna ports identified based on the first FD-OCC sequence length and the first antenna port value.

An apparatus for wireless communication at a base station is described. The apparatus may include a processor, memory coupled with the processor, and instructions stored in the memory. The instructions may be executable by the processor to cause the apparatus to transmit, to a UE, first control signaling indicating a first FD-OCC sequence length of a set of multiple FD-OCC sequence lengths associated with wireless communications with the base station, transmit, to the UE, second control signaling including an indication of a first antenna port value of a set of multiple antenna port values for wireless communications between the UE and the base station, and receive, from the base station, at least one DMRS via at least one antenna port of a set of multiple orthogonal antenna ports identified based on the first FD-OCC sequence length and the first antenna port value.

Another apparatus for wireless communication at a base station is described. The apparatus may include means for transmitting, to a UE, first control signaling indicating a first FD-OCC sequence length of a set of multiple FD-OCC sequence lengths associated with wireless communications with the base station, means for transmitting, to the UE, second control signaling including an indication of a first antenna port value of a set of multiple antenna port values for wireless communications between the UE and the base station, and means for receiving, from the base station, at least one DMRS via at least one antenna port of a set of multiple orthogonal antenna ports identified based on the first FD-OCC sequence length and the first antenna port value.

A non-transitory computer-readable medium storing code for wireless communication at a base station is described. The code may include instructions executable by a processor to transmit, to a UE, first control signaling indicating a first FD-OCC sequence length of a set of multiple FD-OCC sequence lengths associated with wireless communications with the base station, transmit, to the UE, second control signaling including an indication of a first antenna port value of a set of multiple antenna port values for wireless communications between the UE and the base station, and receive, from the base station, at least one DMRS via at least one antenna port of a set of multiple orthogonal antenna ports identified based on the first FD-OCC sequence length and the first antenna port value.

Some examples of the method, apparatuses, and non-transitory computer-readable medium described herein may further include operations, features, means, or instructions for transmitting, via the second control signaling, one or more antenna port field values including the indication of the first antenna port value, the first antenna port value associated with a subset of antenna ports of the set of multiple antenna ports, the subset of antenna ports including the at least one antenna port and transmitting, to the UE based on the one or more antenna port field values, an indication of the at least one antenna port included within the subset of antenna ports, where receiving the at least one DMRS may be based on the indication of the at least one antenna port.

Some examples of the method, apparatuses, and non-transitory computer-readable medium described herein may further include operations, features, means, or instructions for transmitting the indication of the at least one antenna port of the subset of antenna ports via the first control signaling, third control signaling, or both.

Some examples of the method, apparatuses, and non-transitory computer-readable medium described herein may further include operations, features, means, or instructions for transmitting the indication of the at least one antenna port of the subset of antenna ports via one or more additional field values included within the second control signaling.

In some examples of the method, apparatuses, and non-transitory computer-readable medium described herein, the one or more additional field values include a TDRA field value, a FDRA field value, a SRS CS field value, or any combination thereof.

Some examples of the method, apparatuses, and non-transitory computer-readable medium described herein may further include operations, features, means, or instructions for transmitting, via the second control signaling, a set of multiple antenna port field values including the indication of the first antenna port value, the set of multiple antenna port field values including four or more antenna port field values.

Some examples of the method, apparatuses, and non-transitory computer-readable medium described herein may further include operations, features, means, or instructions for transmitting, via the first control signaling or additional control signaling, an activation of at least one antenna port field value of the set of multiple antenna port field values, where transmitting the indication of the first antenna port value may be based on the activation of the at least one antenna port field value.

Some examples of the method, apparatuses, and non-transitory computer-readable medium described herein may further include operations, features, means, or instructions for transmitting, via the first control signaling, the second control signaling, additional control signaling, or any combination thereof, an indication of a rank associated with wireless communications between the UE and the base station, transmitting, via the second control signaling, a set of multiple antenna port field values including the indication of the first antenna port value, and identifying the at least one antenna port based on the set of multiple antenna port field values and the rank.

Some examples of the method, apparatuses, and non-transitory computer-readable medium described herein may further include operations, features, means, or instructions for identifying one or more additional antenna ports of the set of multiple antenna ports based on the set of multiple antenna port field values and the rank, where receiving the at least one DMRS may be based on the one or more additional antenna ports.

Some examples of the method, apparatuses, and non-transitory computer-readable medium described herein may further include operations, features, means, or instructions for identifying a set of CS values, a Walsh sequence, or both, associated with wireless communications between the UE and the base station based on the indication of the first antenna port value and identifying the at least one antenna port of the set of multiple antenna ports in accordance with the set of CS values, the Walsh sequence, or both.

Some examples of the method, apparatuses, and non-transitory computer-readable medium described herein may further include operations, features, means, or instructions for transmitting, to the UE, third control signaling indicating a second FD-OCC sequence length of the set of multiple FD-OCC sequence lengths associated with wireless communications with the base station, the second FD-OCC sequence length different from the first FD-OCC sequence length, receiving, from the base station, fourth control signaling including an indication of a second antenna port value of the set of multiple antenna port values for wireless communications between the UE and the base station, and transmitting, to the base station, at least one additional DMRS via at least one additional antenna port of the set of multiple orthogonal antenna ports identified based on the second FD-OCC sequence length and the second antenna port value.

Some examples of the method, apparatuses, and non-transitory computer-readable medium described herein may further include operations, features, means, or instructions for receiving, from the UE, an indication of a channel quality associated with a channel between the UE and the base station, where transmitting the third control signaling, transmitting the fourth control signaling, or both, may be based at least in a part on receiving the indication of the channel quality.

In some examples of the method, apparatuses, and non-transitory computer-readable medium described herein, the first FD-OCC sequence length may be greater than two.

In some examples of the method, apparatuses, and non-transitory computer-readable medium described herein, the first FD-OCC sequence length may be based on an SCS associated with wireless communications between the UE and the base station, a quantity of frequency combs associated with wireless communications between the UE and the base station, or both.

In some examples of the method, apparatuses, and non-transitory computer-readable medium described herein, the first control signaling includes an RRC message, a MAC-CE message, or both, and the second control signaling includes a DCI message.

In some examples of the method, apparatuses, and non-transitory computer-readable medium described herein, a first subset of the set of multiple orthogonal antenna ports may be orthogonal to a second subset of the set of multiple orthogonal antenna ports.

### BRIEF DESCRIPTION OF THE DRAWINGS

FIG. 1 illustrates an example of a wireless communications system that supports techniques for increased quantities of orthogonal demodulation reference signal (DMRS) ports in accordance with aspects of the present disclosure.

FIG. 2 illustrates an example of a wireless communications system that supports techniques for increased quantities of orthogonal DMRS ports in accordance with aspects of the present disclosure.

FIGS. 3-8 illustrate examples of resource configurations that support techniques for increased quantities of orthogonal DMRS ports in accordance with aspects of the present disclosure.

FIG. 9 illustrates an example of a process flow that supports techniques for increased quantities of orthogonal DMRS ports in accordance with aspects of the present disclosure.

FIGS. 10 and 11 show block diagrams of devices that support techniques for increased quantities of orthogonal DMRS ports in accordance with aspects of the present disclosure.

FIG. 12 shows a block diagram of a communications manager that supports techniques for increased quantities of orthogonal DMRS ports in accordance with aspects of the present disclosure.

FIG. 13 shows a diagram of a system including a device that supports techniques for increased quantities of orthogonal DMRS ports in accordance with aspects of the present disclosure.

FIGS. 14 and 15 show block diagrams of devices that support techniques for increased quantities of orthogonal DMRS ports in accordance with aspects of the present disclosure.

FIG. 16 shows a block diagram of a communications manager that supports techniques for increased quantities of orthogonal DMRS ports in accordance with aspects of the present disclosure.

FIG. 17 shows a diagram of a system including a device that supports techniques for increased quantities of orthogonal DMRS ports in accordance with aspects of the present disclosure.

FIGS. 18 through 21 show flowcharts illustrating methods that support techniques for increased quantities of orthogonal DMRS ports in accordance with aspects of the present disclosure.

### DETAILED DESCRIPTION

Some wireless communications systems may support wireless communications with differing quantities of orthogonal demodulation reference signal (DMRS) ports. In general, higher quantities of orthogonal DMRS ports which are used/enabled may provide for higher quantities of wireless devices (e.g., user equipments (UEs)) to utilize the time/frequency resources. In other words, a higher quantity of DMRS ports may enable a higher quantity of UEs to be multiplexed within a given set of frequency resources. The quantity of orthogonal DMRS ports which are supported may be based on the quantity of frequency domain orthogonal cover codes (FD-OCCs) which are enabled. Some wireless communications systems support only up to two FD-OCCs (e.g., N=2) which may enable up to 12 orthogonal DMRS ports.

Accordingly, aspects of the present disclosure enable techniques for increasing a sequence length of FD-OCCs supported by a wireless communications system, thereby increasing a quantity of available orthogonal DMRS ports for supporting a higher number of spatial layers for uplink transmissions. In particular, techniques described herein are directed to techniques for signaling higher-order FD-OCCs (e.g., having a sequence length N>2), and configurations for indicating antenna port values for higher-quantities of supported DMRS ports. For example, a UE may receive control signaling (e.g., radio resource control (RRC) signaling, medium access control-control element (MAC-CE) signaling) which indicates an FD-OCC sequence length value for wireless communications with the network. The FD-OCC sequence length value may be 4, 6, 8, etc. (e.g., N=4, 6, 8). The UE may then receive an indication of an antenna port value, and may determine which one or more orthogonal DMRS ports are to be used for transmitting DMRSs based on the indicated FD-OCC sequence length value and the antenna port value.

In some cases, antenna port field values in downlink control information (DCI) signaling may indicate a set of antenna ports, where the UE selects an antenna port from the set of antenna ports based on an additional parameter or indication. The additional parameter or indication may be indicated via the RRC/MAC-CE signaling, other control signaling, or by re-interpreting other fields in DCI (e.g., time domain resource allocation (TDRA) fields, frequency domain resource allocation (FDRA) fields, sounding reference signal (SRS) cyclic shift (CS) fields). In other cases, DCI signaling may be configured with additional antenna port field values (e.g., additional bit values) which are used to directly indicate each supported orthogonal DMRS port.

Aspects of the disclosure are initially described in the context of wireless communications systems. Additional aspects of the disclosure are described in the context of example resource configurations and an example process flow. Aspects of the disclosure are further illustrated by and described with reference to apparatus diagrams, system diagrams, and flowcharts that relate to techniques for increased quantities of orthogonal DMRS ports.

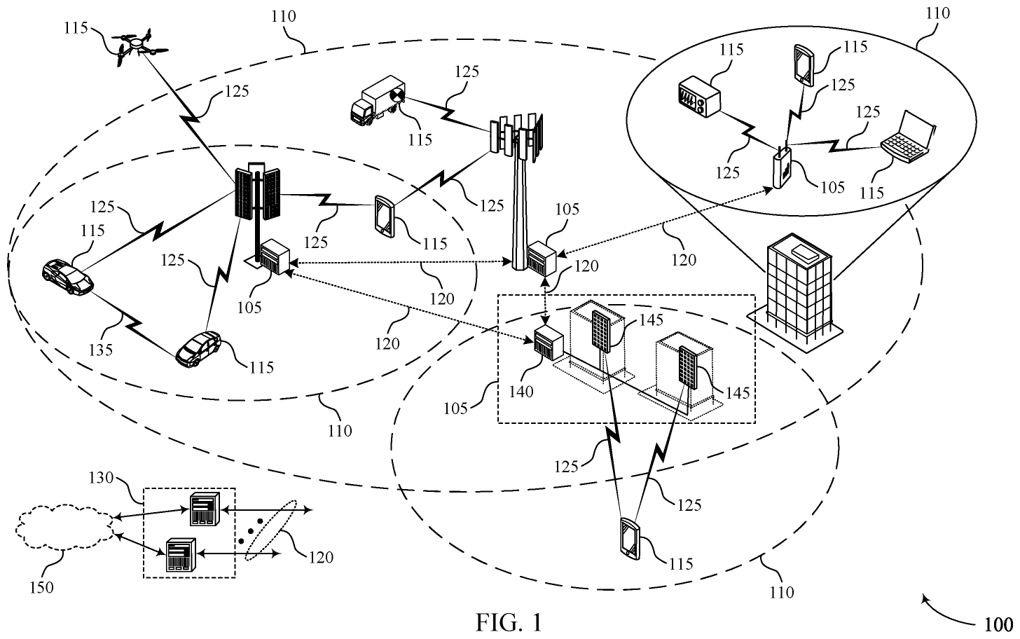

FIG. 1 illustrates an example of a wireless communications system 100 that supports techniques for increased quantities of orthogonal DMRS ports in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing (SCS) are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include an SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported SCS, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on SCS. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The UEs 115 and the base stations 105 of the wireless communications system 100 may support techniques which enable higher quantities of orthogonal DMRS ports for wireless communications. The wireless communications system 100 may enable techniques for increasing a sequence length of FD-OCCs supported by the wireless communications system, thereby increasing a quantity of available orthogonal DMRS ports for supporting a higher number of spatial layers for uplink transmissions. In particular, the wireless communications system 100 may support techniques for signaling higher-order FD-OCCs (e.g., having a sequence length N>2), and configurations for indicating antenna port values for higher-quantities of supported DMRS ports.

For example, a UE 115 of the wireless communications system 100 may receive control signaling (e.g., RRC signaling, MAC-CE signaling, DCI signaling) which indicates an FD-OCC sequence length value for wireless communications with the network. The FD-OCC sequence length value may be 4, 6, 8, etc. (e.g., N=4, 6, 8). The UE may then receive an indication of an antenna port value, and may determine which one or more orthogonal DMRS ports are to be used for transmitting DMRSs based on the indicated FD-OCC sequence length value and the antenna port value. In some aspects, the UE 115 may be configured to identify a set of CS sequence values, a Walsh sequence, or both, based on the indicated antenna port value and the indicated FD-OCC sequence length value, and may determine one or more DMRS ports at the UE 115 which are to be used based on the identified CS values and/or Walsh sequence. In some aspects, a quantity of CS values within the set of CS sequence values and/or the length of the Walsh sequence may be based on the FD-OCC sequence length. In other words, the FD-OCC sequence length may define the length of the CS sequence values and/or the Walsh sequence length.

In some cases, the network (e.g., base station 105) of the wireless communications system 100 may transmit DCI signaling to the UE 115, where the DCI signaling indicates one or more antenna port field values which indicate a set of antenna ports. In such cases, the UE 115 may be configured to select an antenna port from the set of antenna ports based on an additional parameter or indication. The additional parameter or indication may be indicated via the RRC/MAC-CE signaling, other control signaling, or by re-interpreting other fields in DCI (e.g., TDRA fields, FDRA fields, SRS CS fields). In other cases, DCI signaling may be configured with additional antenna port field values (e.g., additional bit values) which are used to directly indicate each supported orthogonal DMRS port.

Techniques described herein may enable wireless communications using higher quantities of orthogonal DMRS ports. In particular, signaling and other configurations described herein may enable wireless communications systems 100 to increase a sequence length of supported FD-OCCs, thereby increasing a quantity of available orthogonal DMRS ports for supporting a higher number of spatial layers for uplink transmissions. As such, by enabling higher quantities of spatial layers for wireless communications, techniques described herein may enable higher quantities of wireless devices (e.g., UEs 115) to perform multiplexed communications within the same frequency resources, thereby improving spectral efficiency within the wireless communications system 100.

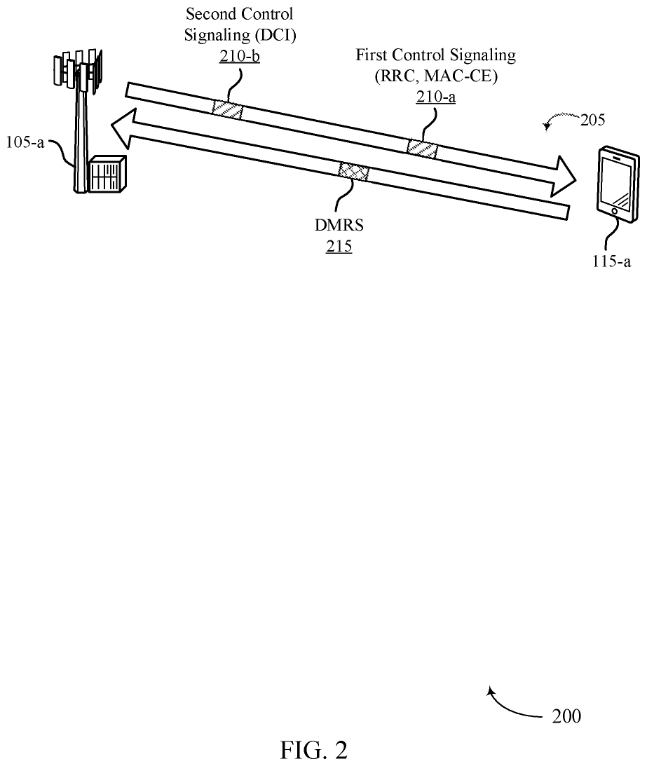

FIG. 2 illustrates an example of a wireless communications system 200 that supports techniques for increased quantities of orthogonal DMRS ports in accordance with aspects of the present disclosure. In some examples, wireless communications system 200 may implement, or be implemented by, aspects of wireless communications system 100. For example, wireless communications system 200 may support increasing a quantity of orthogonal DMRS ports at the UE 115-a, as described in FIG. 1.

The wireless communications system 200 may include a base station 105-a and a UE 115-a, which may be examples base stations 105 and UEs 115 as described with reference to FIG. 1. The UE 115-a may communicate with the base station 105-a using a communication link 205, which may be an example of an NR or LTE link between the UE 115-a and the base station 105-a. In some cases, the communication link 205 between the UE 115-a and the base station 105-a may include an example of an access link (e.g., Uu link) which may include a bi-directional link that enables both uplink and downlink communication. For example, the UE 115-a may transmit uplink signals, such as uplink control signals or uplink data signals (e.g., physical uplink shared channel (PUSCH) transmissions), to the base station 105-a using the communication link 205 and the base station 105-a may transmit downlink signals, such as downlink control signals or downlink data signals, to the UE 115-a using the communication link 205.

As noted previously herein, some wireless communications systems may support wireless communications with differing quantities of orthogonal DMRS ports. In general, higher quantities of orthogonal DMRS ports which are used/enabled may provide for higher quantities of wireless devices (e.g., UEs) to utilize the time/frequency resources. quantity of orthogonal DMRS ports which are supported may be based on the quantity of FD-OCCs which are enabled. Some wireless communications systems support only up to two FD-OCCs (e.g., N=2) which may enable up to 12 orthogonal DMRS ports using DMRS-type=2 (e.g., configuration type-2) DMRS with two symbols (e.g., two FD-OCCs, or N=2). Comparatively, some wireless communications systems may support up to 8 orthogonal DMRS ports when using configuration type-1 DMRS.

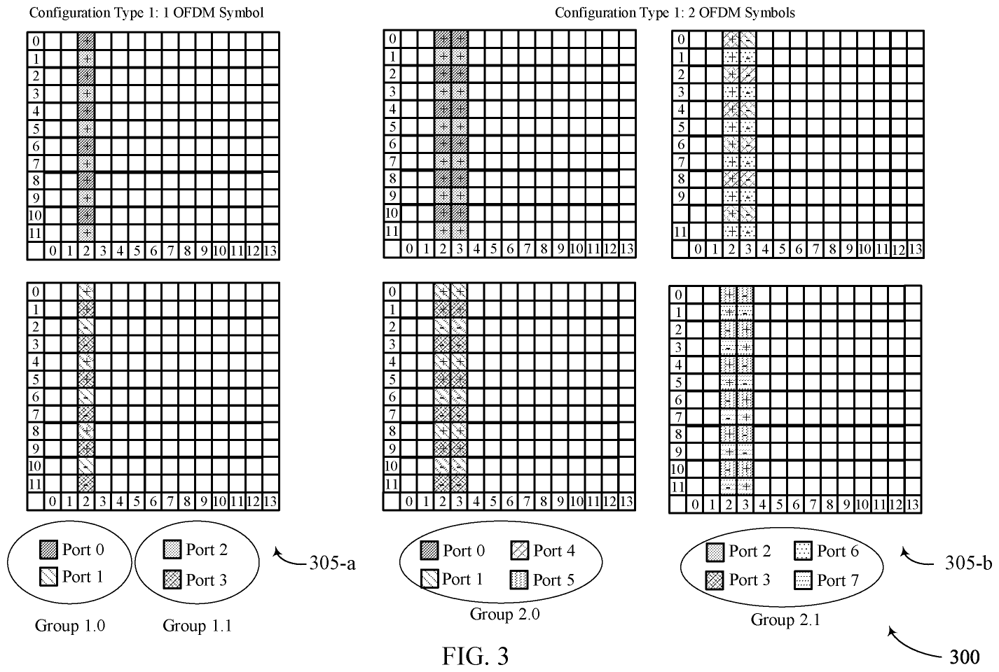

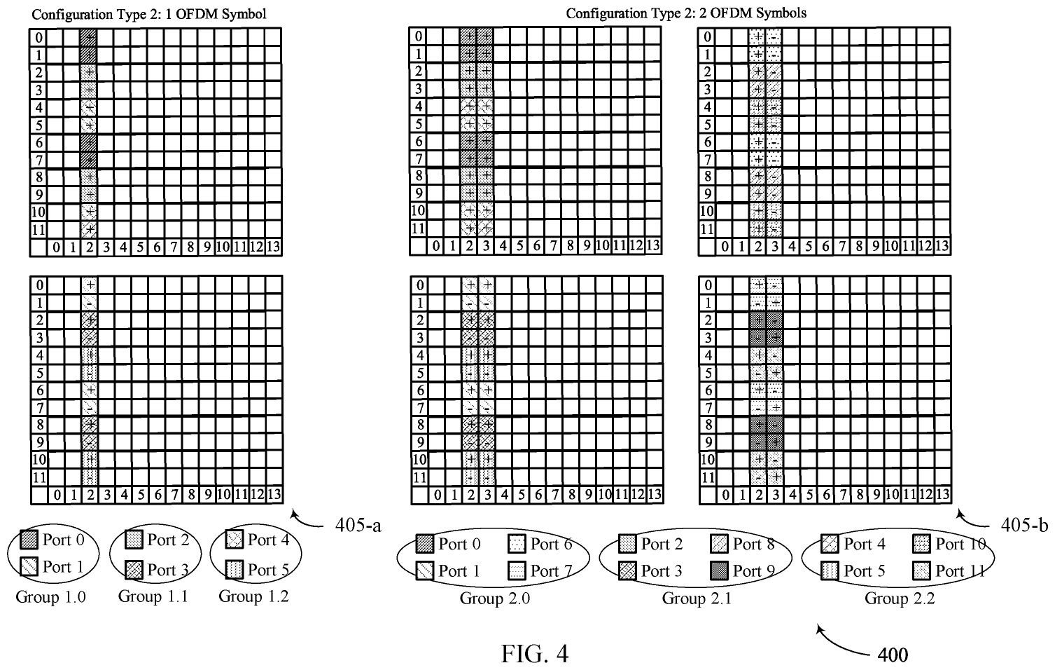

The quantity of supported DMRS ports may provide a limitation for uplink MIMO. In particular, in some wireless communications systems, each UE 115 (e.g., UE 115-a) may transmit up to four layers (e.g., rank=4), where multiple UEs 115 with a total quantity of layers being greater than 12. In order to support higher quantities of UEs 115 within the same frequency resources, aspects of the present disclosure support techniques for increasing a quantity of orthogonal DMRS ports within the DMRS symbol. In particular, techniques described herein are directed to techniques for signaling higher-order FD-OCCs (e.g., having a sequence length N>2), and configurations for indicating antenna port values for higher-quantities of supported DMRS ports. Example DMRS patterns are shown in further detail with respect to FIGS. 3 and 4.

FIGS. 3-4 illustrates examples of a resource configuration 300 and a resource configuration 400, respectively, that support techniques for increased quantities of orthogonal DMRS ports in accordance with aspects of the present disclosure. In some examples, resource configurations 300 and 400 may implement, or be implemented by, aspects of wireless communications system 100, wireless communications system 200, or both.

In particular, resource configuration 300 illustrates a first DMRS configuration 305-a for one OFDM symbol, and a second DMRS configuration 305-b for two OFDM symbols. Similarly, resource configuration 400 illustrates a first DMRS configuration 405-a for one OFDM symbol, and a second DMRS configuration 405-b for two OFDM symbols.

Some wireless communications systems only support two separate DMRS configurations. For example, some wireless communications systems may support a first resource configuration 300 (e.g., config-1), and a second DMRS configuration 400 (e.g., config-2). Config-1 may support up to 8 orthogonal DMRS ports (e.g., 2 FD-OCC×2 comb×2 TD-OCC) with two DMRS symbols, as shown in the first DMRS configuration 305-a and the second DMRS configuration 305-b. Comparatively, config-2 may support up to 12 orthogonal DMRS ports (e.g., 2 FD-OCC×3 comb×2 TD-OCC) with two DMRS symbols, as shown in the first DMRS configuration 405-a and the second DMRS configuration 405-b.

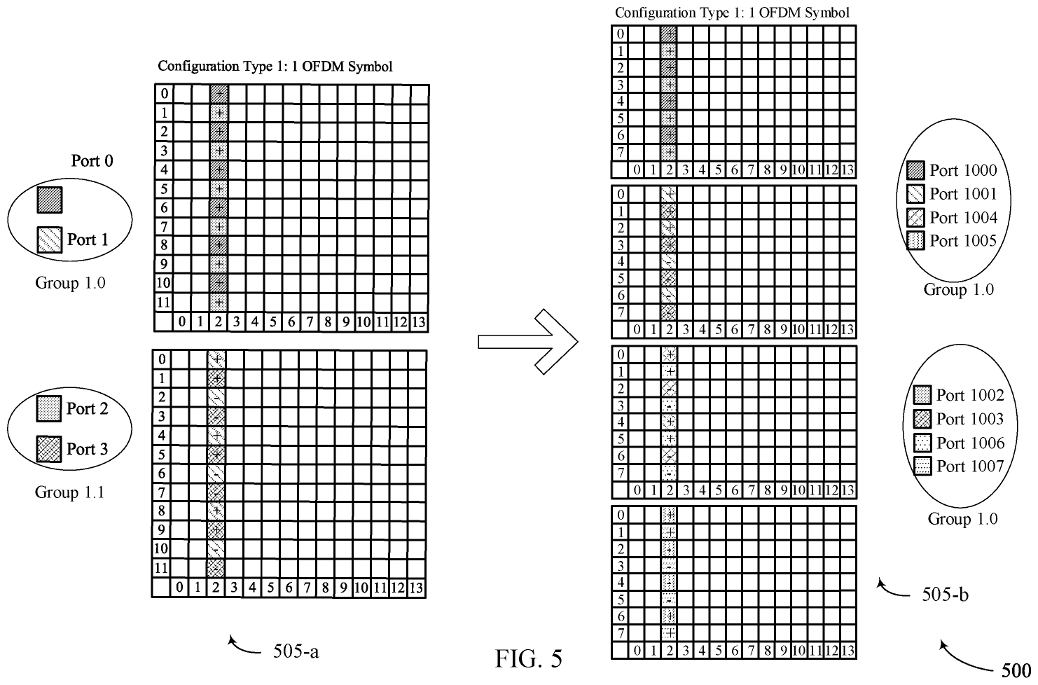

Techniques described herein may enable wireless communications using higher quantities of orthogonal DMRS ports. In particular, signaling and other configurations described herein may enable wireless communications systems 100 to increase a sequence length of supported FD-OCCs, thereby increasing a quantity of available orthogonal DMRS ports for supporting a higher number of spatial layers for uplink transmissions. This may be further shown and described with reference to FIG. 5.

FIG. 5 illustrates an example of a resource configuration 500 that supports techniques for increased quantities of orthogonal DMRS ports in accordance with aspects of the present disclosure. In some examples, resource configuration 500 may implement, or be implemented by, aspects of wireless communications system 100, wireless communications system 200, resource configuration 300, resource configuration 400, or any combination thereof.

Resource configuration 500 illustrates a first DMRS configuration 505-a and a second DMRS configuration 505-b. In some aspects, the first DMRS configuration 505-a illustrates an example of a legacy DMRS configuration which may be implemented by some wireless communications systems. In particular, the first DMRS configuration 505-a may be associated with the Walsh sequence

$$[ \begin{matrix}+ 1 & + 1 \\ + 1 & - 1\end{matrix} ]$$

of length two, corresponding to an FD-OCC sequence length of two (e.g., N=2).

Comparatively, the second DMRS configuration 505-b may include an example DMRS configuration which increases code depth in the frequency domain to multiplex higher quantities of DMRS ports. In particular, the second DMRS configuration 505-b may include an example of a DMRS configuration with a FD-OCC length of four (e.g., N=4). In some aspects, the second DMRS configuration 505-b may be represented as CS-based or OCC based codes in the format: (length-N FD-Codesx2 (or 3) comb×2TD-OCC). Moreover, the second DMRS configuration 505-b may be associated with the Walsh sequence length four (e.g., FD-OCC length four, or N=4) illustrated in Equation 1 below:

$$[ \begin{matrix}+ 1 & + 1 & + 1 & + 1 \\ + 1 & + 1 & - 1 & - 1 \\ + 1 & - 1 & + 1 & - 1 \\ + 1 & - 1 & - 1 & + 1\end{matrix} ] \qquad ( 1 )$$

In accordance with some aspects of the present disclosure, techniques described herein may be used to add additional CS values to support higher quantities of DMRS ports per symbol. The higher quantities of DMRS ports may be applicable to both uplink and downlink communications. Moreover, techniques for adding additional DMRS ports per symbol may be backwards-compatible with legacy (e.g., reduced-capability) UEs 115. Current wireless communications systems may supports two ports per symbol with the Walsh sequence

$$[ \begin{matrix}+ 1 & + 1 \\ + 1 & - 1\end{matrix} ]$$

that maps to CSs of exp (j0) and exp (jπ). For the general case for N ports per comb per symbol, a phase shift of exp (jaᵢn) may be applied to every n^{th} entry of a group of N resource for n=0,1, . . . , N−1 within each comb, where aᵢ defines a phase shift. To keep port nomenclature/configurations backwards-compatible with legacy UEs, phase shifts aᵢ may be determined according to Equation 2 and Equation 3 below:

$${a}_{i} = \frac{2 π}{N} {t}_{i} + {m}_{i} π \qquad ( 2 )$$

$$( {p}_{i} - 1000 ) = 4 ( DMRStype + 1 ) * {t}_{i} + {m}_{i} \qquad ( 3 )$$

for port identifiers pᵢ (port ids) of {1000, 1001, 1002, . . . }, where tᵢ is the largest integer divisor, and mᵢ is the remainder. For double symbols, the same CS may be maintained over time, and TD-OCC may be applied for spreading over time. Moreover, similar to SRS, different CS values may be assigned to different ports, where only the port assignment is different to maintain backwards compatibility.

In accordance with additional or alternative aspects of the present disclosure, techniques described herein may be used to add longer Walsh sequences to support higher quantities of DMRS ports per symbol. By increasing the length of Walsh sequences, and increasing the FD-OCC length, techniques described herein may support more ports per DMRS symbol, which may be applicable to both uplink and downlink communications and may be backwards-compatible with legacy (e.g., reduced-capability) UEs 115.

Current wireless communications systems may supports two ports per symbol with the Walsh sequence

$$[ \begin{matrix}+ 1 & + 1 \\ + 1 & - 1\end{matrix} ]$$

that maps to the rows of Hadamard matrix of size 2×2. For the general case for N ports per comb per symbol, the rows of a Hadamard matrix of size N×N may be applied within each comb, where DMRS port pᵢ may use the aᵢ′th row of the Hadamard matrix. To keep port mapping backwards compatible, phase shifts aᵢ may be determined according to Equation 4 and Equation 5 below:

$${a}_{i} = 2 {t}_{i} + 1 + mod\_ 2 ( {m}_{i} ) \qquad ( 4 )$$

$$( {p}_{i} - 1000 ) = 4 ( DMRStype + 1 ) * {t}_{i} + {m}_{i} \qquad ( 5 )$$

for port identifiers pᵢ (port ids) of {1000, 1001, 1002, . . . }, where tᵢ is the largest integer divisor, and mᵢ is the remainder.

For double symbols, to keep TD-OCC spreading over time, Equations 4 and 5 may be the same as in the CS-based sequences illustrated in Equations 3 and 4. For example, for a FD-OCC length of four (N=4), type-1, single symbol, mappings between DMRS ports and Walsh sequences may be illustrated as follows:
Port 1000/1002->[+1+1+1+1]
Port 1001/1003->[+1−1+1−1]
Port 1000/1002->[+1+1−1-1]
Port 1000/1002->[+1−1-1+1]
   The same CS may be maintained over time, and TD-OCC may be applied for spreading over time. Moreover, similar to SRS, different CS values may be assigned to different ports, where only the port assignment is different to maintain backwards compatibility.

Some wireless communications systems may support FD-OCC length of two (N=2) code over frequency (e.g., w_{f}(k′): k′=0 or 1). In accordance with aspects of the present disclosure, techniques described herein may enable larger FD-OCC lengths. Specifically, techniques described herein may enable FD-OCC lengths larger than two (e.g., N>2). In some cases, the methodology to generalize tables for an arbitrary N value may be performed by changing w_{f}(k′)<-w_{f}(a, k′), as illustrated in Table 1 below:

TABLE 1
w_{f} (a, k′) Values

| | w_{f} (α, k′) |
|---|---|
| CS | ${[ exp ( \frac{j 2 π}{N α ( p ) {k}^{′}} ) ]}_{-} \{ {k}^{′} = 0 , 1 , … , ( N - 1 ) \}$ |
| Walsh | (α, k′) element of N × N Hadamard matrix |

where w_{f}=[+1+1], [+1−1] may correspond to α=0, π for CS values, and where w_{f}=[+1+1], [+1−1] may correspond to α=1, 2 for Walsh sequences.

Example tables mapping DMRS ports to phase shift values (αᵢ) for FD-OCC length four (e.g., N=4) in the context of CS values are shown in Tables 2 and 3 below, where Table 2 illustrates example DMRS port mappings for Type-1 and Table 3 illustrates example DMRS port mappings for Type-2:

TABLE 2
DMRS Port Mappings (N = 4, Type-1)

| | CDM | | | wₜ |
|---|---|---|---|---|
| Port | Group | α(p) | w_{f}(α, k′) | I′ = 0, I′ = 1 |
| 1000 | 0 | 0 | [1 1 1 1] | [1 1] |
| 1001 | 0 | π | [1 −1 1 −1] | [1 1] |
| 1002 | 1 | 0 | [1 1 1 1] | [1 1] |
| 1003 | 1 | π | [1 −1 1 −1] | [1 1] |
| 1004 | 0 | 0 | [1 1 1 1] | [1 −1] |
| 1005 | 0 | π | [1 −1 1 −1] | [1 −1] |
| 1006 | 1 | 0 | [1 1 1 1] | [1 −1] |
| 1007 | 1 | π | [1 −1 1 −1] | [1 −1] |
| 1008 | 0 | π/2 | [1 +j −1 −j] | [1 1] |
| 1009 | 0 | 3π/2 | [1 −j −1 +j] | [1 1] |
| 1010 | 1 | π/2 | [1 +j −1 −j] | [1 1] |
| 1011 | 1 | 3π/2 | [1 −j −1 +j] | [1 1] |
| 1012 | 0 | π/2 | [1 +j −1 −j] | [1 −1] |
| 1013 | 0 | 3π/2 | [1 −j −1 +j] | [1 −1] |
| 1014 | 1 | π/2 | [1 +j −1 −j] | [1 −1] |
| 1015 | 1 | 3π/2 | [1 −j −1 +j] | [1 −1] |

TABLE 3
DMRS Port Mappings (N = 4, Type-2)

| | CDM | | | wₜ |
|---|---|---|---|---|
| Port | Group | α(p) | w_{f}(α, k′) | I′ = 0, I′ = 1 |
| 1000 | 0 | 0 | [1 1 1 1] | [1 1] |
| 1001 | 0 | π | [1 −1 1 −1] | [1 1] |
| 1002 | 1 | 0 | [1 1 1 1] | [1 1] |
| 1003 | 1 | π | [1 −1 1 −1] | [1 1] |
| 1004 | 2 | 0 | [1 1 1 1] | [1 1] |
| 1005 | 2 | π | [1 −1 1 −1] | [1 1] |
| 1006 | 0 | 0 | [1 1 1 1] | [1 −1] |
| 1007 | 0 | π | [1 −1 1 −1] | [1 −1] |
| 1008 | 1 | 0 | [1 1 1 1] | [1 −1] |
| 1009 | 1 | π | [1 −1 1 −1] | [1 −1] |
| 1010 | 2 | 0 | [1 1 1 1] | [1 −1] |
| 1011 | 2 | π | [1 −1 1 −1] | [1 −1] |
| 1012 | 0 | π/2 | [1 +j −1 −j] | [1 1] |
| 1013 | 0 | 3π/2 | [1 −j −1 +j] | [1 1] |
| 1014 | 1 | π/2 | [1 +j −1 −j] | [1 1] |
| 1015 | 1 | 3π/2 | [1 −j −1 +j] | [1 1] |
| 1016 | 2 | π/2 | [1 +j −1 −j] | [1 1] |
| 1017 | 2 | 3π/2 | [1 −j −1 +j] | [1 1] |
| 1018 | 0 | π/2 | [1 +j −1 −j] | [1 −1] |
| 1019 | 0 | 3π/2 | [1 −j −1 +j] | [1 −1] |
| 1020 | 1 | π/2 | [1 +j −1 −j] | [1 −1] |
| 1021 | 1 | 3π/2 | [1 −j −1 +j] | [1 −1] |
| 1022 | 2 | π/2 | [1 +j −1 −j] | [1 −1] |
| 1023 | 2 | 3π/2 | [1 −j −1 +j] | [1 −1] |

In Table 2, the DMRS ports 1000-1003 and 1008-1011 include ports for a single symbol, whereas the DMRS ports 1000-1005 and 1012-1017 include ports for a single symbol in Table 3.

The port mapping for a single symbol described herein may be backwards-compatible with legacy UEs 115. For example, using Equations 2 and 3 above for FD-OCC length four (e.g., N=4) CS, type-1 (8 DMRS ports in total) may be illustrated in Table 4 below:

TABLE 4
Port Mapping For Single Symbol (N = 4, Type-1)

| (pᵢ − 1000) | αᵢ |
|---|---|
| 0, 2 | 0 |
| 1, 3 | π |
| 8, 10 | π/2 |
| 9, 11 | 3π/2 |

Techniques described herein for increasing FD-OCC length (e.g., increasing N) may be scalable to any arbitrary N, as will be described in further detail herein. The rows of Table 4 above (e.g., the respective phase shift values at) may correspond to the following Walsh sequences:

αᵢ=0->[+1+1+1+1]

αᵢ=π->[+1−1+1−1]

αᵢ=π/2>[+1+j−1−j]

αᵢ=3π/2->[+1−j−1+j]

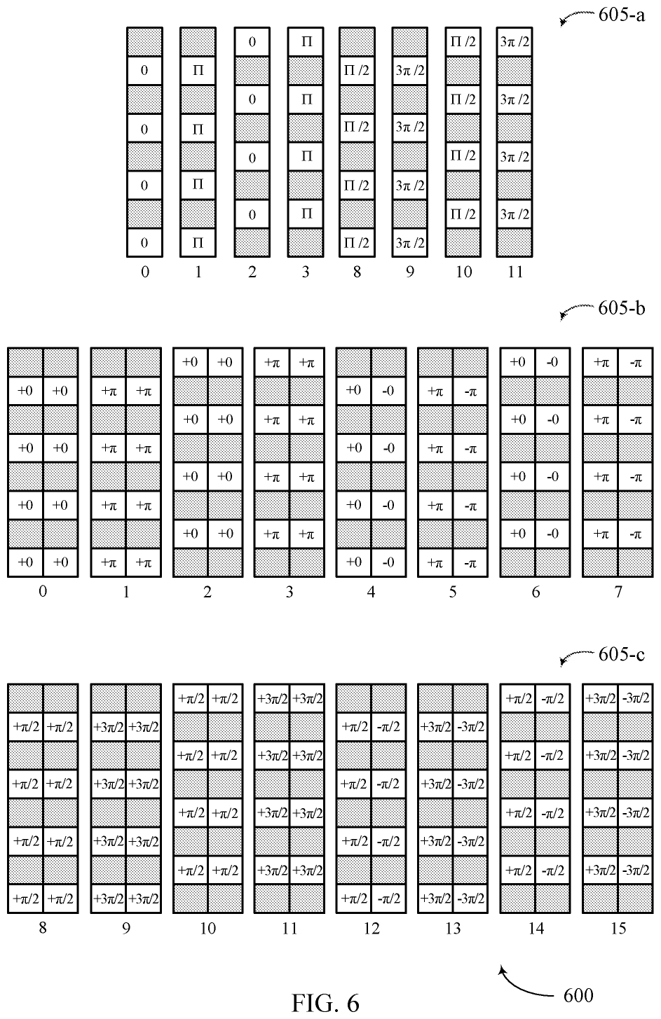

As such, it may be seen that the first two rows of Table 4 above corresponding to αᵢ=0 and π are the same as legacy port mapping. The port mapping illustrated in Table 4 for N=4 may be further shown and described in FIGS. 6-8.

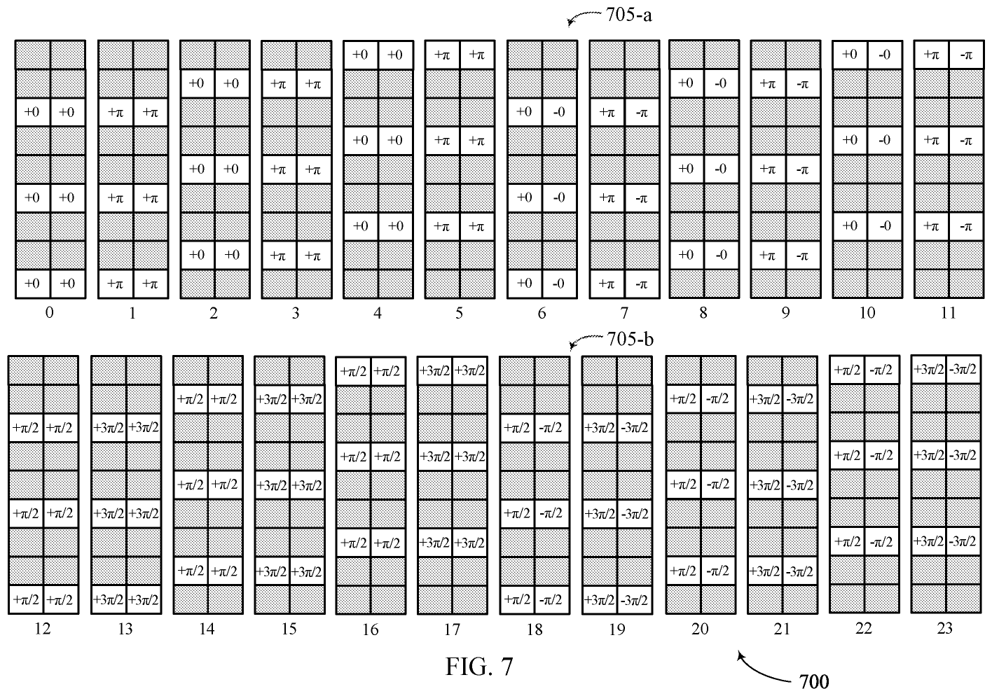

FIGS. 6 and 7 illustrates examples of a resource configuration 600 and a resource configuration 700, respectively, that support techniques for increased quantities of orthogonal DMRS ports in accordance with aspects of the present disclosure. In some examples, resource configuration 700 may implement, or be implemented by, aspects of wireless communications system 100, wireless communications system 200, resource configurations 300-500, or any combination thereof. In particular, resource configurations 600 and 700 illustrate example port mapping configurations 605 and 705 in accordance with aspects of the present disclosure.

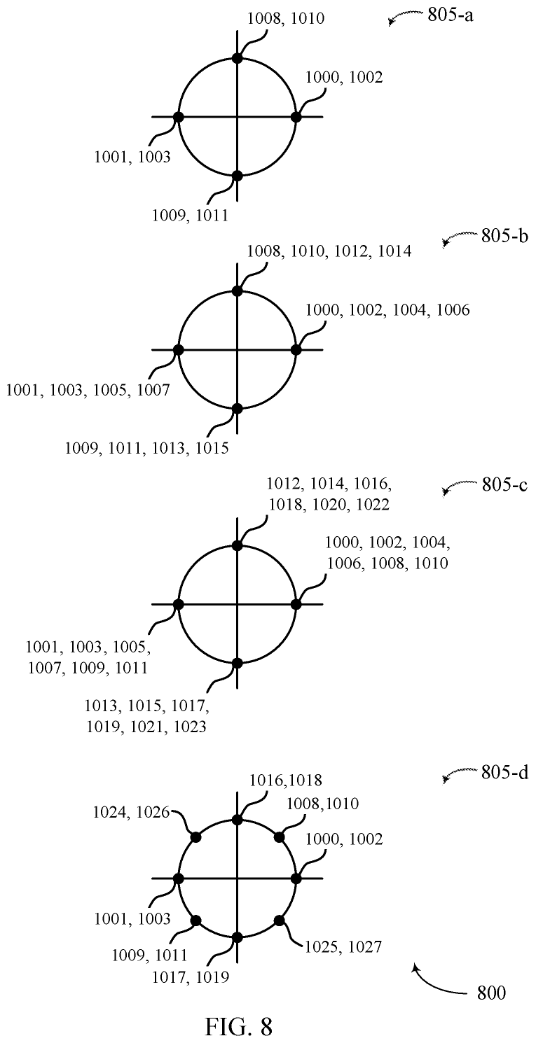

FIG. 8 illustrates examples of resource configurations 800 that support techniques for increased quantities of orthogonal DMRS ports in accordance with aspects of the present disclosure. In some examples, resource configuration 800 may implement, or be implemented by, aspects of wireless communications system 100, wireless communications system 200, resource configurations 300-700, or any combination thereof. In particular, resource configuration 800 illustrates example port mapping configurations 805 in accordance with aspects of the present disclosure.

Reference will again be made to FIG. 2. In some aspects, the network (e.g., base station 105-a) may indicate a FD-OCC sequence length which will be used for wireless communications. For example, as shown in FIG. 2, the base station 105-a may transmit first control signaling (e.g., RRC signaling, MAC-CE signaling, DCI signaling) which indicates an FD-OCC sequence length which will be used for wireless communications between the UE 115-a and the base station 105-a. In other words, the first control signaling may indicate a value of N (e.g., N=2, N=4, N=6, N=8) which will be used to determine which antenna ports (e.g., orthogonal DMRS antenna ports) will be used for wireless communications.

Referring again to the port mapping illustrated in Table 4, the port mapping for a single symbol for FD-OCC length four (e.g., N=4) CS, type-1 (8 DMRS ports in total) may be illustrated via the first port mapping configuration 605-a illustrated in FIG. 6, and the first port mapping configuration 805-a illustrated in FIG. 8. Referring to the first port mapping configuration 605-a illustrated in FIG. 6, the first four ports/columns (e.g., ports/columns 0-3) may be the same as the legacy port mapping for FD-OCC length two (e.g., same for N=2). As such, techniques described herein may enable new port mappings which are illustrated in the last four ports/columns (e.g., ports/columns 8-11) of the port mapping configuration 605-a. Moreover, the port mapping configuration 605-a may be scalable to any N, as will be described in further detail herein.

The port mapping for double symbols described herein may be backwards-compatible with legacy UEs 115, which may be scalable to an arbitrary N. For example, using Equations 2 and 3 above for FD-OCC length four (e.g., N=4) CS, type-1 (16 DMRS ports in total) may be illustrated in Table 5 below:

TABLE 5
Port Mapping for Double Symbol (N = 4, Type-1)

| (pᵢ − 1000) | αᵢ |
|---|---|
| 0, 2, 4, 6 | 0 |
| 1, 3, 5, 7 | π |
| 8, 10, 12, 14 | π/2 |
| 9, 11, 13, 15 | 3π/2 |

The rows of Table 5 above (e.g., the respective phase shift values a) may correspond to the following Walsh sequences:

αᵢ=0>[+1+1+1+1]

αᵢ=π->[+1−1+1−1]

αᵢ=π/2->[+1+j−1−j]

αᵢ=3π/2->[+1−j−1+j]

As such, it may be seen that the first two rows of Table 5 above corresponding to αᵢ=0 and π are the same as legacy port mapping. Moreover, the port mapping illustrated in Table 5 for double symbols and N=4 may be further illustrated via the second port mapping configuration 805-b illustrated in FIG. 8. Further, for double symbol port mapping, within each CS, DMRS ports may be grouped into CDM and TDM such that legacy mapping may be preserved, as shown in Table 6 below:

TABLE 6
CDM/TDM Group Mapping for Double Symbol

| | 1000 | 1002 | 1004 | 1006 |
|---|---|---|---|---|
| CDM Group | 0 | 1 | 0 | 1 |
| TDM Group | 0 | 0 | 1 | 1 |

where TDM group 0 may be represented by a sequence multiplied by (+1) (e.g., +exp (jαᵢn)), and where TDM group 1 may be represented by a sequence multiplied by (−1) (e.g., −exp (jαᵢn)).

The port mappings for double symbols illustrated in Tables 5 and 6 above may be further illustrated via the second port mapping configuration 605-b and the third port mapping configuration 605-c, as illustrated in FIG. 6. Specifically, the second port mapping configuration 605-b in FIG. 6 illustrates legacy port mapping, whereas the third port mapping configuration 605-c illustrates an example port mapping for N=4 double symbols (e.g., CS+comb 2+TD-OCC). The “+” and “−” signs in the third port mapping configuration 605-c represent+exp (jαᵢn) and −exp (jαᵢn), respectively.

The techniques for increasing the quantity of orthogonal DMRS ports per symbol described herein may be applied to any arbitrary FD-OCC length N. However, there are practical limits to the value of N. In particular, FD-OCC length (e.g., value of N) may be limited according to Equation 6 below:

$$Max DelaySpread < 1 / ( Subcarrier Spacing ) * N * ( \# ofCombs ) \qquad ( 6 )$$

where the value of N (e.g., FD-OCC length) may be chosen to satisfy the inequality presented in Equation 6. In particular, choosing a value of N which fails to satisfy the inequality in Equation 6 (e.g., choosing an N which is greater than some threshold value) may result in interference across the respective DMRS ports.

Reference will again be made to FIG. 2. In some aspects, the base station 105-a of the wireless communications system 100 may be configured to indicate an FD-OCC length (e.g., value of N) to the UE 115-a via the first control signaling 210-a (e.g., RRC, MAC-CE). In particular, the FD-OCC length which will be used for wireless communications, as well as the DMRS port mapping configuration which will be used, may be up to the network (e.g., base station 105-a). The indication to the UE 115-a (e.g., αᵢ->CS) may be up to the base station 105-a as to how to assign ports to different UEs 115 based on the CS values. The port id. (pᵢ) may determine the CS, where the base station 105-a indicates the port id. (pᵢ) (or equivalent CS) within the antenna field of DCI messages communicated to the UE 115-a. Additionally, or alternatively, depending on the quantity of layers (e.g., rank) supported at the UE 115-a, the base station 105-a may assign either multiple CS values within the same CDM group, or multiple CDM groups with fewer CS values. The specific CDM group/CS configuration may be determined by the base station 105-a, and signaled to the UE 115-a via DCI signaling.

In some aspects, DMRS port assignments may be indicated via an antenna port field(s) of a DCI message (DCI 0_1) communicated to the UE 115-a. For example, as shown in FIG. 2, the UE 115-b may receive second control signaling (e.g., DCI message) which includes an indication of one an antenna port value. DCI signaling may include one or more antenna port field values which correspond to one or more antenna ports.

According to some aspects of the present disclosure, the quantity of orthogonal DMRS ports may be increased to enable higher quantities of multiplexed UEs 115 per resource. In order to accommodate higher quantities of DMRS ports, and to enable DCI messages to indicate higher quantities of DMRS ports, several solutions/implementations are proposed herein.

In accordance with a first implementation, antenna port fields in DCI (e.g., second control signaling 210-b) may be indicative of sets of DMRS ports, and an additional parameter (e.g., RRC parameter) may be used to indicate which DMRS port of the set of DMRS ports is to be used. One advantage of the first implementation is that it requires no increased overhead to DCI signaling (e.g., no changes to DCI format, no additional bits). In other words, the first implementation enables a no-DCI-overhead solution to indicate which CS value is selected from the set of antenna ports associated with the antenna port field of DCI. In some cases, the base station 105-a may configure a new RRC parameter to indicate the differential CS. In other words, each antenna port field value may be indicative of a set of DMRS ports, and the base station 105-a may utilize an additional parameter/value to indicate which DMRS port(s) from the set of DMRS ports is to be used.

In some aspects, the additional parameter/indication used to select the DMRS port(s) may be indicated via the first control signaling 210-a (e.g., via RRC signaling, MAC-CE signaling, DCI signaling). Additionally, or alternatively, the additional parameter/indication used to select the DMRS port(s) within the first implementation may be indicated via another field in DCI (e.g., via another field in the second control signaling 210-b). For example, TDRA field values (e.g., TDRA table) within a DCI message may be re-interpreted as indicating which DMRS port from the set of DMRS ports is to be used (e.g., implicit indication). In other cases, some new port mapping configurations may be assigned to reserved values within DMRS mapping tables, particularly for double symbol mapping where the quantity of reserved values is large. This may facilitate the indication of DMRS ports without any increased signaling/control overhead. Other fields within the second control signaling 210-b which may be used to indicate which antenna port(s) are to be used may include FDRA fields, SRS CS fields, and the like.

Comparatively, in accordance with a second implementation, the format of DCI signaling (e.g., format of the second control signaling 210-b) may be adjusted to add one or more bit(s) to the DCI signaling in order to indicate the additional DMRS ports enabled by aspects of the present disclosure. In other words, the second control signaling 210-b (e.g., DCI message) may be altered to include one or more additional antenna port fields (e.g., increase the quantity of bits from three to four) to provide indications for more DMRS ports. In some cases, the presence of the extra bit(s) in the DCI message may be controlled (e.g., activated) via RRC configuration or other control signaling. As compared to the first implementation, which required no additional signaling overhead, the second implementation would require additional signaling overhead due to the additional fields/bits which would be added to the DCI message.

In some implementations, the use of the respective implementations (e.g., first implementation with no increased overhead, second implementation with increased overhead) may be dependent on network conditions and/or the presence of certain conditions/thresholds. For example, in some cases, the UE 115-a and the base station 105-a may utilize the first implementation for larger ranks (e.g., more reserved values), and may utilize the second implementation for smaller ranks.

The first control signaling 210-a and/or the second control signaling 210-b may indicate other parameters/characteristics associated with wireless communications between the respective devices, such as the type of port mapping (e.g., Type-1, Type-2), a symbol configuration for port mapping (e.g., single symbol port mapping, double symbol port mapping), and the like.

Upon receiving the first control signaling 210-a (e.g., RRC, MAC-CE, DCI) indicating the FD-OCC sequence length and the second control signaling 210-b (e.g., DCI message) indicating the antenna port value, the UE 115-a may utilize the FD-OCC sequence length and the antenna port value to determine which orthogonal DMRS port(s) are to be used for wireless communications with the base station 105-b. In particular, the UE 115-a may utilize the FD-OCC sequence length and the antenna port value to determine which orthogonal DMRS port(s) are to be used for transmitting a DMRS 215 to the base station. In particular, upon determining one or more antenna ports based on the FD-OCC sequence length and the antenna port value, the UE 115-a may utilize the one or more antenna ports to determine a set of CS values and/or a Walsh sequence which will be used to transmit the DMRS 215 to the base station 105-a. Subsequently, the UE 115-a may transmit the DMRS 215 in accordance with the identified antenna ports and the identified CS values/Walsh sequence.

An example may prove to be illustrative. In the context of the first implementation for signaling higher quantities of DMRS ports, antenna port field values in the DCI message (e.g., second control signaling 210-b) may be mapped to a set(s) of DMRS ports, as shown in Tables 7 and 8 below:

TABLE 7
Implementation 1: DMRS Port Mapping
(N = 4, Single Symbol, Rank 1, Type-1)

| Antenna | # DMRS CDM Group(s) | |
|---|---|---|
| Port Value | without Data | DMRS Port(s) |
| 0 | 1 | 0, 8 |
| 1 | 1 | 1, 9 |
| 2 | 2 | 0, 8 |
| 3 | 2 | 1, 9 |
| 4 | 2 | 2, 10 |
| 5 | 2 | 3, 11 |
| 6-7 | Reserved | Reserved |

TABLE 8
Implementation 1: DMRS Port Mapping
(N = 4, Single Symbol, Rank 1, Type-1)

| Antenna | # DMRS CDM Group(s) | |
|---|---|---|
| Port Value | without Data | DMRS Port(s) |
| 0 | 1 | 0, 9 |
| 1 | 1 | 1, 8 |
| 2 | 2 | 0, 9 |
| 3 | 2 | 1, 8 |
| 4 | 2 | 2, 11 |
| 5 | 2 | 3, 10 |
| 6-7 | Reserved | Reserved |

Tables 7 and 8 illustrate example port mapping configurations with 90 degree CS for FD-OCC length four (N=4). As shown in Tables 7 and 8, each antenna port field value in the left column indicates a set of DMRS ports. For example, referring to Table 7, antenna port field value-0 indicates DMRS ports 0 and 8, whereas antenna port field value=1 indicates DMRS ports 1 and 9. There can be multiple ways to create other tables for mapping DMRS ports to antenna port field values by combining existing ports with new ports (e.g., different combinations of DMRS ports in the left DMRS column and the right DMRS column.

The example DMRS port mappings illustrated in Tables 7 and 8 (and throughout the application) may also be extended from CS-based mapping schemes to Walsh-based mapping schemes. Moreover, the DMRS port mappings illustrated in Tables 7 and 8 may be further illustrated in the port mapping configuration 605-a illustrated in FIG. 6 and the port mapping configuration 805-a illustrated in FIG. 8.

Comparatively, DMRS port mapping performed in accordance with the second implementation (e.g., implementation which adds bits to the DCI message for indicating additional DMRS ports) may be further illustrated in Table 9 below:

TABLE 9
Implementation 2: DMRS Port Mapping
(N = 4, Single Symbol, Rank 1, Type-1)

| Antenna | # DMRS CDM Group(s) | |
|---|---|---|
| Port Value | without Data | DMRS Port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |
| 8 | 1 | 8 |
| 9 | 1 | 9 |
| 10 | 2 | 8 |
| 11 | 2 | 9 |
| 12 | 2 | 10 |
| 13 | 2 | 11 |
| 14-15 | Reserved | Reserved |

As compared to Tables 7 and 8 above, which map multiple DMRS ports to each antenna port field value, each antenna port field value in Table 9 indicates a single DMRS port. Adding additional bits to the antenna port field value in the DCI message may enable larger quantities of antenna port field values, which may then be used to indicate the increased quantity of DMRS ports which are enabled by the present disclosure. The example DMRS port mappings illustrated in Table 9 may also be extended from CS-based mapping schemes to Walsh-based mapping schemes. Moreover, the DMRS port mappings illustrated in Table 9 may be further illustrated in the port mapping configuration 605-a illustrated in FIG. 6 and the port mapping configuration 805-a illustrated in FIG. 8.

Tables 7-9 above provide example DMRS port mappings for the first and second implementations in the context of rank-1 communications. Comparatively, Tables 10 and 11 below illustrates an example port mapping scheme for rank-2 communications (Type-1, symbol, N=4, rank-2).

TABLE 10
Implementation 1: DMRS Port Mapping
(N = 4, Single Symbol, Rank 2, Type-1)

| | | |
|---|---|---|
| Antenna | # DMRS CDM Group(s) | |
| Port Value | without Data | DMRS Port(s) |

| | | | |
|---|---|---|---|
| 0 | 1 | (0, 1) | (8, 9) |
| 1 | 2 | (0, 1) | (8, 9) |
| 2 | 2 | (2, 3) | (10, 11) |
| 3 | 2 | (0, 2) | (8, 10) |

| | | |
|---|---|---|
| 4-7 | Reserved | Reserved |

TABLE 11
Implementation 2: DMRS Port Mapping
(N = 4, Single Symbol, Rank 2, Type-1)

| Antenna | # DMRS CDM Group(s) | |
|---|---|---|
| Port Value | without Data | DMRS Port(s) |
| 0 | 1 | (0, 1) |
| 1 | 2 | (0, 1) |
| 2 | 2 | (2, 3) |
| 3 | 2 | (0, 2) |
| 4 | 1 | (8, 9) |
| 5 | 2 | (8, 9) |
| 6 | 2 | (10, 11) |
| 7 | 2 | (8, 10) |

As may be seen by comparing Table 10 and Table 11, each antenna port field value in Table 10 (first implementation) is mapped to multiple pairs of DMRS ports, whereas each antenna port field value in Table 11 (second implementation) is mapped to a single DMRS ports. In this regard, Table 10 illustrates an example port mapping which adds additional DMRS port mappings for each existing antenna port field value. In accordance with the first implementation, the UE 115-a may receive an additional indication/parameter (e.g., via RRC, MAC-CE, or other fields in DCI such as TDRA or FDRA) which would indicate which pair of DMRS ports associated with an indicated antenna port field value are to be used from Table 10 (e.g., whether the pair of DMRS ports in the left or right column should be used for an indicated port value). Comparatively, Table 11 includes additional antenna port field values which are enabled by adding one or more additional bits to the antenna port field in the DCI message. The DMRS port mappings illustrated in Tables 10 and 11 may be further illustrated in the port mapping configuration 605-a illustrated in FIG. 6.

Tables 12-13 below provide example DMRS port mappings for the first and second implementations in the context of rank-3 communications. Specifically, Table 12 provides an example DMRS port mapping scheme for the first implementation (Type-1, single symbol, Rank 3, N=2), and Table 13 provides an example DMRS port mapping scheme for the second implementation (Type-1, single symbol, Rank 3, N=2).

TABLE 12
Implementation 1: DMRS Port Mapping
(N = 4, Single Symbol, Rank 3, Type-1)

| | | |
|---|---|---|
| Antenna | # DMRS CDM Group(s) | |
| Port Value | without Data | DMRS Port(s) |

| | | | |
|---|---|---|---|
| 0 | 2 | (0-2) | (8-10) |

| | | |
|---|---|---|
| 1-7 | Reserved | Reserved |

TABLE 13
Implementation 2: DMRS Port Mapping
(N = 4, Single Symbol, Rank 3, Type-1)

| Antenna | # DMRS CDM Group(s) | |
|---|---|---|
| Port Value | without Data | DMRS Port(s) |
| 0 | 2 | 0-2 |
| 1 | 1 | 0, 1, 8 |
| 2 | 2 | 8, 9, 10 |
| 3-7 | Reserved | Reserved |

As may be seen in Tables 12-13 above, larger FD-OCC lengths (e.g., larger values of N) may enable port mapping options with a single CDM group for rank>2. In accordance with the first implementation, the UE 115-a may receive an additional indication/parameter (e.g., via RRC, MAC-CE, or other fields in DCI such as TDRA or FDRA) which would indicate which pair of DMRS ports associated with an indicated antenna port field value are to be used from Table 12 (e.g., whether the pair of DMRS ports in the left or right column should be used for an indicated port value). The larger the rank, the more reserved values, where using reserved values may be more reasonable. Moreover, as described herein, a combination of the first implementation (Table 12) and the second implementation (Table 13) may be used when reserved values are limited and when there are new CDM groups. The DMRS port mappings illustrated in Tables 12-13 may be further illustrated in the port mapping configuration 605-a illustrated in FIG. 6 and the port mapping configuration 805-a illustrated in FIG. 8.

Tables 14-15 below provide example DMRS port mappings for the first and second implementations in the context of rank-4 communications. Specifically, Table 14 provides an example DMRS port mapping scheme for the first implementation (Type-1, single symbol, Rank 4, N=2), and Table 15 provides an example DMRS port mapping scheme for the second implementation (Type-1, single symbol, Rank 4, N=2).

TABLE 14
Implementation 1: DMRS Port Mapping
(N = 4, Single Symbol, Rank 4, Type-1)

| | | |
|---|---|---|
| Antenna | # DMRS CDM Group(s) | |
| Port Value | without Data | DMRS Port(s) |

| | | | |
|---|---|---|---|
| 0 | 2 | 0-3 | 8-11 |

| | | |
|---|---|---|
| 1-7 | Reserved | Reserved |

TABLE 15
Implementation 1: DMRS Port Mapping
(N = 4, Single Symbol, Rank 4, Type-1)

| Antenna | # DMRS CDM Group(s) | |
|---|---|---|
| Port Value | without Data | DMRS Port(s) |
| 0 | 2 | 0-3 |
| 1 | 1 | 0, 1, 8, 9 |
| 2 | 2 | 8-11 |
| 3-7 | Reserved | Reserved |

As may be seen in Tables 14-15 above, larger FD-OCC lengths (e.g., larger values of N) may enable port mapping options with a single CDM group for rank>2. In accordance with the first implementation, the UE 115-a may receive an additional indication/parameter which would indicate which pair of DMRS ports associated with an indicated antenna port field value are to be used from Table 14 (e.g., whether the pair of DMRS ports in the left or right column should be used for an indicated port value). The larger the rank, the more reserved values, where using reserved values may be more reasonable. Moreover, as described herein, a combination of the first implementation (Table 14) and the second implementation (Table 15) may be used when reserved values are limited and when there are new CDM groups. The DMRS port mappings illustrated in Tables 14-15 may be further illustrated in the port mapping configuration 605-a illustrated in FIG. 6 and the port mapping configuration 805-a illustrated in FIG. 8.

Example DMRS mapping schemes shown and described above have been illustrated in the context of FD-OCC length four (e.g., N=4). However, aspects of the present disclosure may enable DMRS mappings for larger FD-OCC lengths (e.g., N=6, 8, etc.). For example, Table 16 below provides an example DMRS port mapping for the first implementations in the context of rank-2 communications for FD-OCC length eight (N=8). Specifically, Table 16 provides an example DMRS port mapping scheme for the first implementation (Type-1, single symbol, Rank 2, N=8).

TABLE 16
Implementation 1: DMRS Port Mapping
(N = 4, Single Symbol, Rank 4, Type-1)

| Antenna | # DMRS CDM Group(s) | | | | |
|---|---|---|---|---|---|
| Port Value | without Data | DMRS Port(s) | | | |
| 0 | 1 | (0, 1) | (8, 9) | (16, 17) | (24, 25) |
| 1 | 2 | (0, 1) | (8, 9) | (16, 17) | (24, 25) |
| 2 | 2 | (2, 3) | (10, 11) | (18, 19) | (26, 27) |
| 3 | 2 | (0, 2) | (8, 10) | (16, 18) | (24, 26) |

| | | |
|---|---|---|
| 4-7 | Reserved | Reserved |

As may be seen in Table 16 above, for longer FD-OCC lengths (e.g., N=8), there are more DMRS port mappings to select from for each antenna port field value. For example, for antenna port field value=0, there are four pairs of DMRS ports to select from: (0,1), (8,9), (16,17), and (24,25). Accordingly, in cases where the DCI message indicates antenna port field value-0, the UE 115-a may receive an additional indication/parameter (e.g., via RRC, MAC-CE, or other fields in DCI such as TDRA or FDRA) which would indicate which pair of DMRS ports associated with antenna port field value-0 are to be used from Table 16. The DMRS port mappings illustrated in Table 16 may be further illustrated in the port mapping configuration 805-d illustrated in FIG. 8 (45° separation between each respective DMRS port).

Example DMRS mapping schemes shown and described above have been illustrated in the context of single symbol DMRS mapping. However, aspects of the present disclosure may enable DMRS mappings for other configurations, such as double symbol. For example, the second port mapping configuration 605-b and the third port mapping configuration 605-c shown in FIG. 6 illustrate a DMRS port mapping scheme for FD-OCC length 2 (N=2), type-1, double symbol, and rank-2. Further, double symbol port mapping from the port mapping configurations 605-b, 605-c on FIG. 6 may correspond to the second port mapping configuration 805-b illustrated in FIG. 8. For each double symbol, techniques described herein may be configured to group DMRS ports into DCM and TDM groups such that legacy mapping is preserved, as illustrated in the TD-OCC mapping shown in Table 6 above.

Table 17 below illustrates an example DMRS port mapping scheme for the second implementation in the context of double symbol, rank-2 communications. Specifically, Table 17 provides an example DMRS port mapping scheme for the second implementation Type-1, double symbol, Rank 2, N=4.

TABLE 17
Implementation 2: DMRS Port Mapping
(N = 4, Double Symbol, Rank 2, Type-1)

| Antenna | # DMRS CDM Group(s) | # front loaded | |
|---|---|---|---|
| Port Value | without Data | symb | DMRS Port(s) |
| 0 | 1 | 1 | (0, 1), (8, 9) |
| 1 | 2 | 1 | (0, 1), (8, 9) |
| 2 | 2 | 1 | (2, 3), (10, 11) |
| 3 | 2 | 1 | (0, 2), (8, 10) |
| 4 | 2 | 2 | (0, 1), (8, 9) |
| 5 | 2 | 2 | (2, 3), (10, 11) |
| 6 | 2 | 2 | (4, 5), (12, 13) |
| 7 | 2 | 2 | (6, 7), (14, 15) |
| 8 | 2 | 2 | (0, 4), (8, 12) |
| 9 | 2 | 2 | (2, 6), (10, 14) |
| 10-15 | Reserved | Reserved | Reserved |

Further, double symbol port mapping shown in Table 17 may correspond to the second port mapping configuration 805-b illustrated in FIG. 8. For each double symbol, techniques described herein may be configured to group DMRS ports into DCM and TDM groups such that legacy mapping is preserved, as illustrated in the TD-OCC mapping shown in Table 6 above.

Tables 18 below illustrates an example DMRS port mapping scheme for double symbol, Type-1, Rank 3, N=4. The DMRS port mapping scheme illustrated in Table 18 corresponds to the second and third port mapping configurations 605-b, 605-c illustrated in FIG. 6, as well as the second port mapping configuration 805-b illustrated in FIG. 8.

TABLE 18
DMRS Port Mapping (N = 4, Double Symbol, Rank 3, Type-1)

| Antenna | # DMRS CDM Group(s) | # front loaded | |
|---|---|---|---|
| Port Value | without Data | symb | DMRS Port(s) |
| 0 | 2 | 1 | (0-2) |
| 1 | 2 | 2 | (0, 1, 4) |
| 2 | 2 | 2 | (2, 3, 6) |
| 3 | 2 | 1 | (8-10) |
| 4 | 2 | 2 | (8, 9, 12) |
| 5 | 2 | 2 | (10, 11, 14) |
| 6 | 1 | 2 | (0, 1, 8) |
| 7-15 | Reserved | Reserved | Reserved |

Table 19 below illustrates an example DMRS port mapping scheme for double symbol, Type-1, Rank 4, N=4. The DMRS port mapping scheme illustrated in Table 19 corresponds to the second and third port mapping configurations 605-b, 605-c illustrated in FIG. 6, as well as the second port mapping configuration 805-b illustrated in FIG. 8.

TABLE 19
DMRS Port Mapping (N = 4, Double Symbol, Rank 4, Type-1)

| Antenna | # DMRS CDM Group(s) | # front loaded | |
|---|---|---|---|
| Port Value | without Data | symb | DMRS Port(s) |
| 0 | 2 | 1 | (0-3) |
| 1 | 2 | 2 | (0, 1, 4, 5) |
| 2 | 2 | 2 | (2, 3, 6, 7) |
| 3 | 2 | 2 | (0, 2, 4, 6) |
| 4 | 2 | 1 | (8-11) |
| 5 | 2 | 2 | (8, 9, 12, 13) |
| 6 | 2 | 2 | (10, 11, 14, 15) |
| 7 | 2 | 2 | (8, 10, 12, 14) |
| 8-15 | Reserved | Reserved | Reserved |

Table 20 below illustrates an example DMRS port mapping scheme for Type-2 port mapping. In particular, Table 20 illustrates a DMRS port mapping scheme for double symbol, Type-2, Rank 2, N=4. The DMRS port mapping scheme illustrated in Table 20 corresponds to the first and second port mapping configurations 705-a, 705-b illustrated in FIG. 7, as well as the third port mapping configuration 805-c illustrated in FIG. 8. Moreover, the TD-OCC mapping for the DMRS mapping scheme illustrated in Table 20 is shown in Table 21.

TABLE 20
DMRS Port Mapping (N = 4, Double Symbol, Rank 2, Type-2)

| Antenna | # DMRS CDM Group(s) | # front loaded | |
|---|---|---|---|
| Port Value | without Data | symb | DMRS Port(s) |
| 0 | 1 | 1 | (0, 1), (12, 13) |
| 1 | 2 | 1 | (0, 1), (12, 13) |
| 2 | 2 | 1 | (2, 3), (14, 15) |
| 3 | 3 | 1 | (0, 1), (12, 13) |
| 4 | 3 | 1 | (2, 3), (14, 15) |
| 5 | 3 | 1 | (4, 5), (16, 17) |
| 6 | 2 | 1 | (0, 2), (12, 14) |
| 7 | 3 | 2 | (0, 1), (12, 13) |
| 8 | 3 | 2 | (2, 3), (14, 15) |
| 9 | 3 | 2 | (4, 5), (16, 17) |
| 10 | 3 | 2 | (6, 7), (18, 19) |
| 11 | 3 | 2 | (8, 9), (20, 21) |
| 12 | 3 | 2 | (10, 11), (22, 23) |
| 13 | 1 | 2 | (0, 1), (12, 13) |
| 14 | 1 | 2 | (6, 7), (18, 19) |
| 15 | 2 | 2 | (0, 1), (12, 13) |
| 16 | 2 | 2 | (2, 3), (14, 15) |
| 17 | 2 | 2 | (6, 7), (18, 19) |
| 18 | 2 | 2 | (8, 9), (20, 21) |
| 19-31 | Reserved | Reserved | Reserved |

TABLE 21
CDM/TDM Group Mapping (N =
4, Double Symbol, Rank 2, Type-2)

| | 1000 | 1002 | 1004 | 1006 | 1008 | 1010 |
|---|---|---|---|---|---|---|
| CDM Group | 0 | 1 | 2 | 0 | 1 | 2 |
| TDM Group | 0 | 0 | 0 | 1 | 1 | 1 |

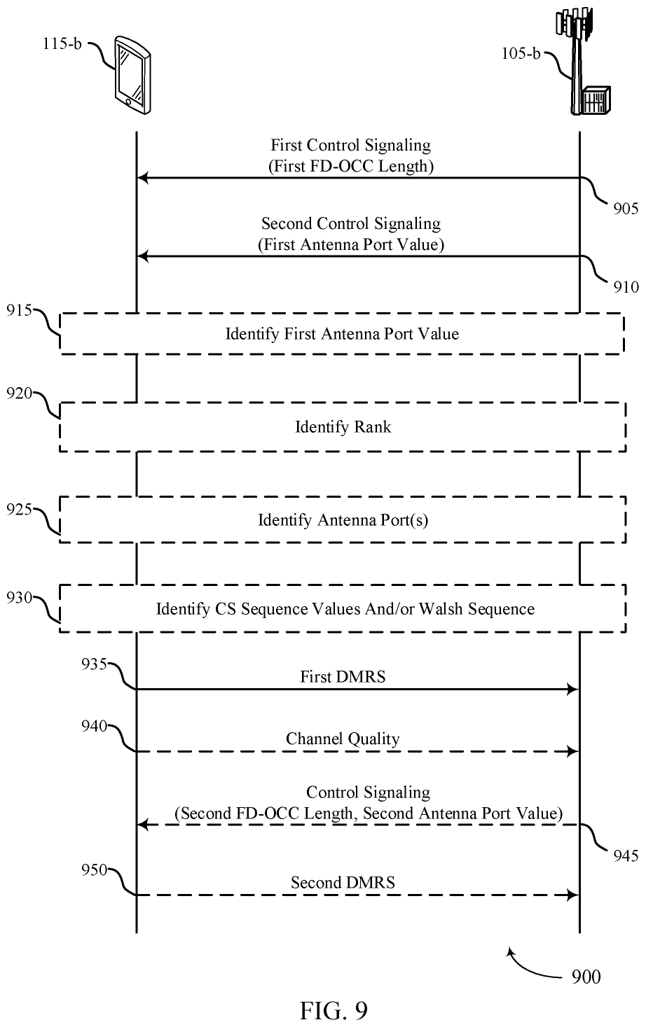

FIG. 9 illustrates an example of a process flow 900 that supports techniques for increased quantities of orthogonal DMRS ports in accordance with aspects of the present disclosure. In some examples, process flow 900 may implement, or be implemented by, aspects of wireless communications system 100, wireless communications system 200, resource configurations 300-800, or any combination thereof. For example, the process flow 900 may illustrate a UE 115-b receiving an indication of a FD-OCC length from a base station 105-b, receiving an indication of an antenna port field value, identifying one or more antenna ports, and transmitting a DMRS using the identified antenna ports, as described with reference to FIGS. 1-8.

In some cases, process flow 900 may include a UE 115-b and a base station 105-b, which may be examples of corresponding devices as described herein. In particular, the UE 115-b and the base station 105-b illustrated in FIG. 9 may include examples of the UE 115-a and the base station 105-a illustrated in FIG. 2.

In some examples, the operations illustrated in process flow 900 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 905, the UE 115-b may receive, from the base station, first control signaling indicating a first FD-OCC sequence length for wireless communications with the base station 105-b. In other words, the first control signaling may indicate a value of N, as described herein. The first FD-OCC sequence length may be included within a set of FD-OCC sequence lengths associated with wireless communications within the network, where the set of FD-OCC sequence lengths may be pre-configured, signaled by the network (e.g., via RRC signaling, MAC-CE signaling), or both. In this regard, the first control signaling may include RRC signaling, MAC-CE signaling, or both.

In some aspects, the first FD-OCC length may be greater than two (e.g., N>2). For example, as described previously herein, aspects of the present disclosure may enable for higher-order FD-OCC sequence lengths, such as N=4, N=6, N=8, and the like. The FD-OCC length may be determined, or based on, one or more characteristics or parameters associated with wireless communications between the UE 115-b and the base station 105-b. For example, as shown in Equation 6 above, the first FD-OCC length may be based on an SCS associated with wireless communications between the UE 115-b and the base station 105-b, a quantity of frequency combs associated with wireless communications between the UE 115-b and the base station 105-b, and the like. Moreover, the base station 105-b may set the first FD-OCC length based on network conditions, such as channel quality, levels of noise or interference, and the like. Moreover, the UE 115-b and the base station 105-b may utilize the first FD-OCC sequence length to determine which table from Tables 7-20 (or which table from a set of similar tables) will be used to determine the DMRS port(s) which will be used for wireless communications between the respective devices.

At 910, the UE 115-b may receive, from the base station 105-b, second control signaling including an indication of a first antenna port value. The first antenna port value may be included within a set of antenna port values for wireless communications between the UE 115-b and the base station 105-b, where the set of antenna port values may be pre-configured, signaled to the UE 115-b via RRC or MAC-CE signaling, or both. For example, the second control signaling may indicate an antenna port value as illustrated in the left columns of Tables 7-20 above, which will be used to determine which DMRS port(s) will be used for wireless communications between the respective devices.

In some implementations, the second control signaling may include a DCI message. For example, the second control signaling at 310 may include a DCI message including one or more antenna port field values which indicate the first antenna port value. In this regard, in some implementations, the first control signaling at 910 and the second control signaling at 910 may include separate signaling and/or separate control messages. However, in alternative implementations, the first and second control signaling may include the same control signaling. For example, in some cases, the UE 115-b may receive a single control message (e.g., RRC message) which includes the indication of the first FD-OCC sequence length, and the first antenna port value.

At 915, the UE 115-b, the base station 105-b, or both, may identify the first antenna port value. For example, the UE 115-b may identify the first antenna port value via the second control signaling at 910. In particular, the UE 115-b may identify the first antenna port value via one or more antenna port field values included within a DCI message (e.g., second control signaling) received at 910.

At 920, the UE 115-b, the base station 105-b, or both, may identify a rank associated with wireless communications between the UE 115-b and the base station 105-b. The UE 115-b and the base station 105-b may identify the rank based on the first control signaling at 905, the second control signaling at 910, or both. In other words, the first control signaling and/or the second control signaling may include an indication of the rank. For example, in cases where the first control signaling includes an RRC message and/or a MAC-CE message, the RRC/MAC-CE message may include an indication of the rank. By way of another example, in cases where the second control signaling includes a DCI message, the DCI message may include an indication of the rank.

As shown previously herein, the rank may indicate a quantity of DMRS ports which will be used for wireless communications between the UE 115-b and the base station 105-b. Moreover, the UE 115-b and the base station 105-b may utilize the rank to determine which table from Tables 7-20 (or which table from a set of similar tables) will be used to determine the DMRS port(s) which will be used for wireless communications between the respective devices based on the first FD-OCC sequence length and the first antenna port value.

Additionally, or alternatively, the UE 115-b and/or the base station 105-b may identify other parameters/characteristics associated with wireless communications between the respective devices, such as the type of port mapping (e.g., Type-1, Type-2), a symbol configuration for port mapping (e.g., single symbol port mapping, double symbol port mapping), and the like. In some implementations, these parameters may be signaled to the UE 115-b via the first control signaling (e.g., RRC, MAC-CE), the second control signaling (e.g., DCI), additional control signaling, or any combination thereof. In other cases, these parameters may be pre-configured at the UE 115-b.

At 925, the UE 115-b, the base station 105-b, or both, may identify one or more antenna ports (e.g., orthogonal DMRS ports) for wireless communications between the UE 115-b and the base station 105-b. The one or more antenna ports identified at 930 may be included within a set of orthogonal antenna ports (e.g., set of orthogonal DMRS ports) for wireless communications between the respective devices. The set of orthogonal antenna ports from which the one or more antenna ports are identified may be pre-configured, signaled to the UE 115-b (e.g., via RRC and/or MAC-CE signaling), or both. Moreover, at least a first subset of the set of orthogonal antenna ports may be orthogonal to a second subset of the set of orthogonal antenna ports.

The UE 115-b and/or base station 105-b may identify the one or more antenna ports at 925 based on transmitting/receiving the first control signaling at 905, transmitting/receiving the second control signaling at 910, identifying the first antenna port value at 915, identifying the rank at 920, or any combination thereof. For example, in some implementations, the UE 115-b and the base station 105-b may identify the one or more antenna ports based on the first FD-OCC sequence length indicated via the first control signaling, and the first antenna port value indicated via the second control signaling. In particular, the UE 115-b and/or the base station 105-b may identify the one or more antenna ports using one of Tables 7-20 (or similar tables). Moreover, the quantity of antenna ports which are identified/selected at 930 may be dependent upon the rank of wireless communications between the respective devices, which was determined at 920.

As noted previously herein, the UE 115-b and/or the base station 105-b may utilize multiple implementations for determining antenna ports based on indicated FD-OCC sequence lengths and antenna port values. A first implementation may utilize additional indications/parameters which are used to indicate the additional supported DMRS values, and may not result in any overhead impact. Comparatively, a second implementation may add additional bits (e.g., additional antenna port fields) in DCI which are used to indicate the additional supported DMRS values, and may result in increased control overhead.

In some aspects, the network may indicate (e.g., via the first control signaling, via the second control signaling) which implementation will be used to determine antenna port values. In other cases, the UE 115-b may be pre-configured to utilize one of the first or second implementations. Additionally, or alternatively, the use of the respective implementations (e.g., first implementation with no increased overhead, second implementation with increased overhead) may be dependent on network conditions and/or the presence of certain conditions/thresholds. For example, in some cases, the UE 115-a and the base station 105-a may utilize the first implementation for larger ranks (e.g., more reserved values), and may utilize the second implementation for smaller ranks.

In accordance with the first implementation, the antenna port value indicated in the second control signaling (e.g., indicated in DCI) may correspond to a subset of potential antenna port values (e.g., candidate antenna port values) which will be used. In the context of the first implementation, an additional indication/parameter may be used to identify which antenna port value from the subset of candidate antenna port values will be used.

For example, referring to Table 7 above, the second control signaling may indicate antenna port value=3, which corresponds to antenna ports 1 and 9. In this example, an additional indication/parameter may be signaled to the UE 115-b which indicates which of the two antenna ports should be used (e.g., indicates antenna port 1 or antenna port 9. By way of another example, referring to Table 10 above, the second control signaling may indicate antenna port value-0, which corresponds to antenna port pair (0,1) and antenna port pair (8,9). In this example, an additional indication/parameter may be signaled to the UE 115-b which indicates which of the two antenna port pairs should be used (e.g., indicates antenna port pair (0, 1) or antenna port pair (8, 9).

The additional indication/parameter which is used to identify which antenna port will be used may be indicated via the first control signaling (e.g., via RRC or MAC-CE), via additional control signaling (e.g., via third control signaling), or both. Additionally, or alternatively, the additional indication/parameters used to identify which antenna port will be used from the subset of candidate antenna ports may be determined by re-interpreting one or more fields in DCI. For example, the DCI message (e.g., second control signaling) may include one or more TDRA field values, FDRA field values, SRS CS field values, or any combination thereof, which are used (re-interpreted) to determine which antenna port(s) from the set of candidate antenna ports is to be used.

Comparatively, in accordance with the second implementation for identifying antenna ports, DCI signaling (e.g., second control signaling) may include additional bits (e.g., additional antenna port fields) which are used to indicate the additional supported DMRS values. As described herein, the second implementation may result in increased control overhead. For example, the quantity of antenna port fields in DCI may be increased from three antenna port field values to four antenna port field values (e.g., increased from three bits to four bits) to enable indication of higher quantities of antenna ports.

In some aspects, the additional bit within the second control signaling (e.g., additional antenna port field values) may be enabled, triggered, or otherwise activated by the base station 105-b. For example, in some aspects, the first control signaling may indicate an activation of an additional antenna port field value within the second control signaling. An activation of additional bits/antenna port field values may serve as an indication that the UE 115-b is to use the second implementation.

With the second implementation, additional antenna port field values may enable for more direct indication of antenna port(s) without the use of an additional parameter/indication used in the first implementation (but at the cost of increased overhead). For example, referring to Table 9 above, additional antenna port filed values in DCI may be used to indicate the corresponding DMRS ports. For instance, continuing with reference to Table 9, if the second control signaling (DCI) indicates antenna port value=13, the UE 115-b and/or the base station 105-b may identify that DMRS port 11 is to be used for communications between the respective devices. By way of another example, referring to Table 17, if the antenna port value indicates antenna port field value=9, the UE 115-b and/or the base station 105-b may identify that antenna port pairs (2, 6) and (10, 14) are to be used for communications between the respective devices.

At 930, the UE 115-b and/or the base station 105-b may identify a set of CS values, a Walsh sequence, or both, associated with wireless communications between the UE 115-b and the base station 105-b. In some aspects, the UE 115-b and/or the base station 105-b may identify the set of one or more CS values and/or the Walsh sequence based on the first antenna port value indicated via the second control signaling at 910 and the FD-OCC length indicated in the first control signaling 905. Moreover, the UE 115-b may identify the set of CS values and the Walsh sequence based on the one or more ports identified at 925.

In some aspects, a length of the CS sequence values within the set of one or more CS sequence values and/or the length of the Walsh sequence may be the same as the FD-OCC sequence length. In other words, the FD-OCC sequence length may define the quantity of one or more CS values of the same length as the FD-OCC sequence length and/or the Walsh sequence length. For example, the UE 115-b may determine the set of CS values and/or the Walsh sequence based on the determined rank and the FD-OCC sequence length, and may select/identify a set of CS values and/or a Walsh sequence that corresponds to the respective DMRS ports from the appropriate port mapping table described herein (e.g., using one of Tables 7-20 or similar tables).

At 935, the UE 115-b may transmit a first DMRS to the base station 105-b via (e.g., using) the one or more antenna ports which were identified at 925. In particular, the UE 115-b may transmit the first DMRS using (e.g., in accordance with) the identified CS values and/or Walsh sequence identified at 930. In this regard, the UE 115-b may transmit the first DMRS at 935 based on transmitting/receiving the first control signaling at 905, transmitting/receiving the second control signaling at 910, identifying the first antenna port value at 915, identifying the rank at 920, identifying the one or more antenna ports at 925, identifying the set of CS values and/or Walsh sequence at 930, or any combination thereof.

In some implementations, the network (e.g., base station 105-b) may semi-statically or dynamically adjust the antenna port(s) which are used for wireless communications between the UE 115-b and the base station 105-b. The network may adjust the antenna port(s) which are used for wireless communications based on network conditions, indications of channel quality received from the UE 115-b, or both. In such cases, the process flow 900 may proceed to 940.

At 940, the UE 115-b may transmit an indication of channel quality associated with a channel between the UE 115-b and the base station 105-b. For example, the UE 115-b may transmit a channel quality indicator (CQI) or channel quality report to the base station 105-b.

At 945, the base station 105-b may transmit additional control signaling (e.g., RRC, MAC-CE, DCI) to the UE 115-b, where the additional control signaling indicates a second FD-OCC sequence length and/or a second antenna port value. For example, the base station 105-b may transmit an RRC/MAC-CE message which indicates a second FD-OCC sequence length, and a DCI message which indicates a second antenna port value, as shown and described at 905 and 910. In particular, the base station 105-b may dynamically change the FD-OCC sequence length and/or the antenna port value via the control signaling at 945 based on (e.g., in response to) the indication of channel quality received at 940.

The UE 115-b and/or the base station 105-b may perform any of the steps/functions shown and described at 905-930 based on the indication of the second FD-OCC sequence length and/or second antenna port value indicated at 945. In other words, the UE 115-b may identify the second antenna port value (915), the rank (920), and/or the one or more antenna ports (925) based on the additional control signaling received at 945. Moreover, the UE 115-b may identify a second set of CS values and/or second Walsh sequence (930) based on the additional control signaling at 945.

At 950, the UE 115-b may transmit a second DMRS to the base station 105-b via (e.g., using) the one or more antenna ports which were identified based on the control signaling received at 945. In particular, the UE 115-b may identify one or more antenna ports based on the second FD-OCC sequence length and/or the second antenna port value indicated at 945, and may transmit a second DMRS using the identified ports.

Techniques described herein may enable wireless communications using higher quantities of orthogonal DMRS ports. In particular, signaling and other configurations described herein may enable the UE 115-b and the base station 105-b to increase a sequence length of supported FD-OCCs, thereby increasing a quantity of available orthogonal DMRS ports for supporting a higher number of spatial layers for uplink transmissions. As such, by enabling higher quantities of spatial layers for wireless communications, techniques described herein may enable higher quantities of wireless devices (e.g., UEs 115) to perform multiplexed communications within the same frequency resources, thereby improving spectral efficiency within the wireless communications system.

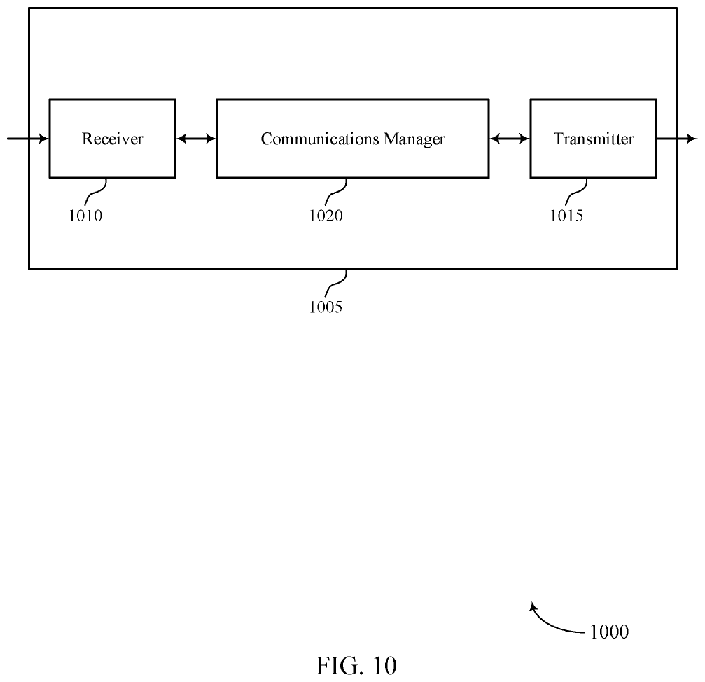

FIG. 10 shows a block diagram 1000 of a device 1005 that supports techniques for increased quantities of orthogonal DMRS ports in accordance with aspects of the present disclosure. The device 1005 may be an example of aspects of a UE 115 as described herein. The device 1005 may include a receiver 1010, a transmitter 1015, and a communications manager 1020. The device 1005 may also include one or more processors, memory coupled with the one or more processors, and instructions stored in the memory that are executable by the one or more processors to enable increased quantities of orthogonal DMRS ports, as discussed herein. . . . Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for increased quantities of orthogonal DMRS ports). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for increased quantities of orthogonal DMRS ports). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for increased quantities of orthogonal DMRS ports as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. For example, the communications manager 1020 may be configured as or otherwise support a means for receiving, from a base station, first control signaling indicating a first FD-OCC sequence length of a set of multiple FD-OCC sequence lengths associated with wireless communications with the base station. The communications manager 1020 may be configured as or otherwise support a means for receiving, from the base station, second control signaling including an indication of a first antenna port value of a set of multiple antenna port values for wireless communications between the UE and the base station. The communications manager 1020 may be configured as or otherwise support a means for transmitting, to the base station, at least one DMRS via at least one antenna port of a set of multiple orthogonal antenna ports identified based on the first FD-OCC sequence length and the first antenna port value.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may enable wireless communications using higher quantities of orthogonal DMRS ports. In particular, signaling and other configurations described herein may enable wireless communications systems 100 to increase a sequence length of supported FD-OCCs, thereby increasing a quantity of available orthogonal DMRS ports for supporting a higher number of spatial layers for uplink transmissions. As such, by enabling higher quantities of spatial layers for wireless communications, techniques described herein may enable higher quantities of wireless devices (e.g., UEs 115) to perform multiplexed communications within the same frequency resources, thereby improving spectral efficiency within the wireless communications system 100.

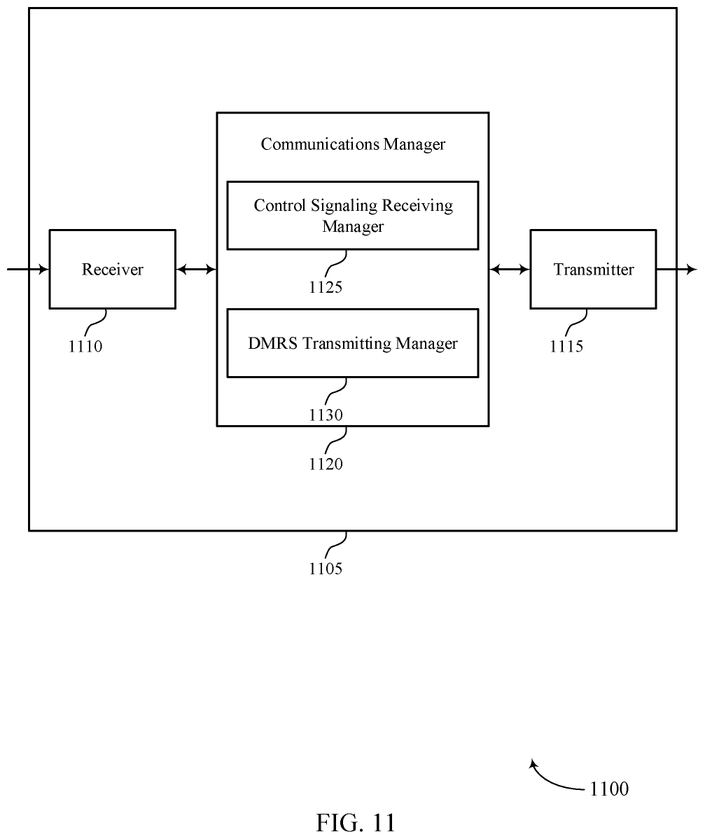

FIG. 11 shows a block diagram 1100 of a device 1105 that supports techniques for increased quantities of orthogonal DMRS ports in accordance with aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for increased quantities of orthogonal DMRS ports). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for increased quantities of orthogonal DMRS ports). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for increased quantities of orthogonal DMRS ports as described herein. For example, the communications manager 1120 may include a control signaling receiving manager 1125 a DMRS transmitting manager 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. The control signaling receiving manager 1125 may be configured as or otherwise support a means for receiving, from a base station, first control signaling indicating a first FD-OCC sequence length of a set of multiple FD-OCC sequence lengths associated with wireless communications with the base station. The control signaling receiving manager 1125 may be configured as or otherwise support a means for receiving, from the base station, second control signaling including an indication of a first antenna port value of a set of multiple antenna port values for wireless communications between the UE and the base station. The DMRS transmitting manager 1130 may be configured as or otherwise support a means for transmitting, to the base station, at least one DMRS via at least one antenna port of a set of multiple orthogonal antenna ports identified based on the first FD-OCC sequence length and the first antenna port value.

In some cases, the control signaling receiving manager 1125 and the DMRS transmitting manager 1130 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling receiving manager 1125 and the DMRS transmitting manager 1130 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

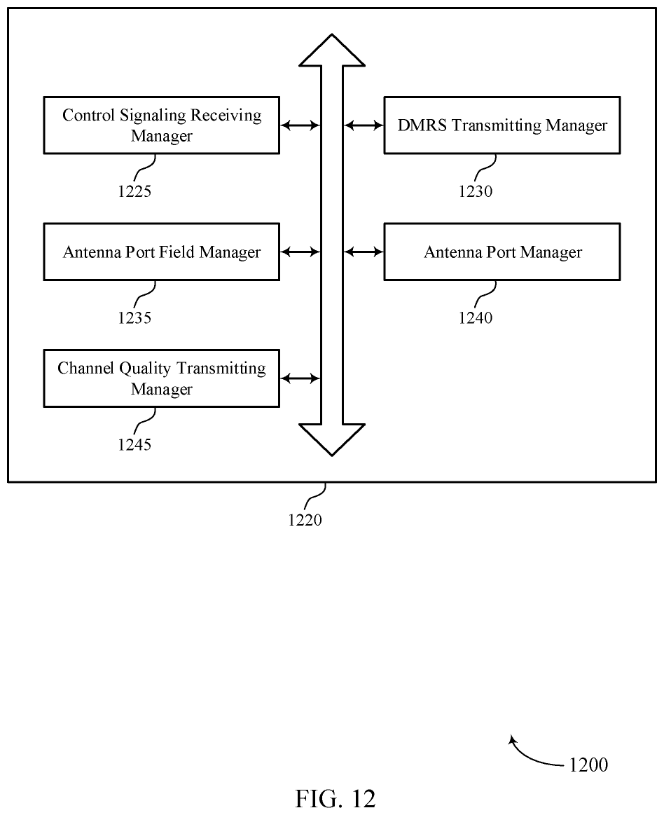

FIG. 12 shows a block diagram 1200 of a communications manager 1220 that supports techniques for increased quantities of orthogonal DMRS ports in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for increased quantities of orthogonal DMRS ports as described herein. For example, the communications manager 1220 may include a control signaling receiving manager 1225, a DMRS transmitting manager 1230, an antenna port field manager 1235, an antenna port manager 1240, a channel quality transmitting manager 1245, or any combination thereof. Each of these components may communicate, directly or indirectly, with one another (e.g., via one or more buses).

The communications manager 1220 may support wireless communication at a UE in accordance with examples as disclosed herein. The control signaling receiving manager 1225 may be configured as or otherwise support a means for receiving, from a base station, first control signaling indicating a first FD-OCC sequence length of a set of multiple FD-OCC sequence lengths associated with wireless communications with the base station. In some examples, the control signaling receiving manager 1225 may be configured as or otherwise support a means for receiving, from the base station, second control signaling including an indication of a first antenna port value of a set of multiple antenna port values for wireless communications between the UE and the base station. The DMRS transmitting manager 1230 may be configured as or otherwise support a means for transmitting, to the base station, at least one DMRS via at least one antenna port of a set of multiple orthogonal antenna ports identified based on the first FD-OCC sequence length and the first antenna port value.

In some examples, the control signaling receiving manager 1225 may be configured as or otherwise support a means for receiving, via the second control signaling, one or more antenna port field values including the indication of the first antenna port value, the first antenna port value associated with a subset of antenna ports of the set of multiple antenna ports, the subset of antenna ports including the at least one antenna port. In some examples, the antenna port field manager 1235 may be configured as or otherwise support a means for receiving, from the base station based on the one or more antenna port field values, an indication of the at least one antenna port included within the subset of antenna ports, where transmitting the at least one DMRS is based on the indication of the at least one antenna port.

In some examples, the control signaling receiving manager 1225 may be configured as or otherwise support a means for receiving the indication of the at least one antenna port of the subset of antenna ports via the first control signaling, third control signaling, or both. In some examples, the control signaling receiving manager 1225 may be configured as or otherwise support a means for receiving the indication of the at least one antenna port of the subset of antenna ports via one or more additional field values included within the second control signaling. In some examples, the one or more additional field values include a TDRA field value, a FDRA field value, a sounding reference signal CS field value, or any combination thereof.

In some examples, the control signaling receiving manager 1225 may be configured as or otherwise support a means for receiving, via the second control signaling, a set of multiple antenna port field values including the indication of the first antenna port value, the set of multiple antenna port field values including four or more antenna port field values.

In some examples, the antenna port field manager 1235 may be configured as or otherwise support a means for receiving, via the first control signaling or additional control signaling, an activation of at least one antenna port field value of the set of multiple antenna port field values, where receiving the indication of the first antenna port value is based on the activation of the at least one antenna port field value.

In some examples, the control signaling receiving manager 1225 may be configured as or otherwise support a means for receiving, via the first control signaling, the second control signaling, additional control signaling, or any combination thereof, an indication of a rank associated with wireless communications between the UE and the base station. In some examples, the control signaling receiving manager 1225 may be configured as or otherwise support a means for receiving, via the second control signaling, a set of multiple antenna port field values including the indication of the first antenna port value. In some examples, the antenna port manager 1240 may be configured as or otherwise support a means for identifying the at least one antenna port based on the set of multiple antenna port field values and the rank.

In some examples, the antenna port manager 1240 may be configured as or otherwise support a means for identifying one or more additional antenna ports of the set of multiple antenna ports based on the set of multiple antenna port field values and the rank, where transmitting the at least one DMRS is based on the one or more additional antenna ports.

In some examples, the antenna port field manager 1235 may be configured as or otherwise support a means for identifying a set of CS values, a Walsh sequence, or both, associated with wireless communications between the UE and the base station based on the indication of the first antenna port value. In some examples, the antenna port manager 1240 may be configured as or otherwise support a means for identifying the at least one antenna port of the set of multiple antenna ports in accordance with the set of CS values, the Walsh sequence, or both.

In some examples, the control signaling receiving manager 1225 may be configured as or otherwise support a means for receiving, from the base station, third control signaling indicating a second FD-OCC sequence length of the set of multiple FD-OCC sequence lengths associated with wireless communications with the base station, the second FD-OCC sequence length different from the first FD-OCC sequence length. In some examples, the control signaling receiving manager 1225 may be configured as or otherwise support a means for receiving, from the base station, fourth control signaling including an indication of a second antenna port value of the set of multiple antenna port values for wireless communications between the UE and the base station. In some examples, the DMRS transmitting manager 1230 may be configured as or otherwise support a means for transmitting, to the base station, at least one additional DMRS via at least one additional antenna port of the set of multiple orthogonal antenna ports identified based on the second FD-OCC sequence length and the second antenna port value.

In some examples, the channel quality transmitting manager 1245 may be configured as or otherwise support a means for transmitting, to the base station, an indication of a channel quality associated with a channel between the UE and the base station, where receiving the third control signaling, receiving the fourth control signaling, or both, is based at least in a part on transmitting the indication of the channel quality.

In some examples, the first FD-OCC sequence length is greater than two. In some examples, the first FD-OCC sequence length is based on an SCS associated with wireless communications between the UE and the base station, a quantity of frequency combs associated with wireless communications between the UE and the base station, or both. In some examples, the first control signaling includes an RRC message, a MAC-CE message, or both. In some examples, the second control signaling includes a DCI message. In some examples, a first subset of the set of multiple orthogonal antenna ports are orthogonal to a second subset of the set of multiple orthogonal antenna ports.

In some cases, the control signaling receiving manager 1225, the DMRS transmitting manager 1230, the antenna port field manager 1235, the antenna port manager 1240, and the channel quality transmitting manager 1245 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling receiving manager 1225, the DMRS transmitting manager 1230, the antenna port field manager 1235, the antenna port manager 1240, and the channel quality transmitting manager 1245 discussed herein.

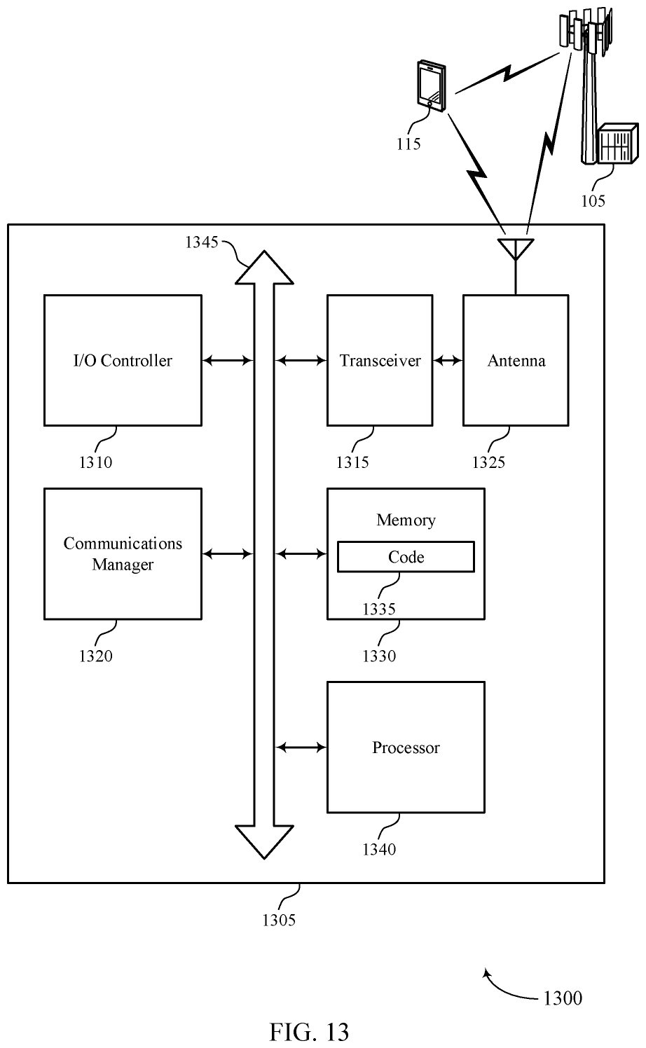

FIG. 13 shows a diagram of a system 1300 including a device 1305 that supports techniques for increased quantities of orthogonal DMRS ports in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for increased quantities of orthogonal DMRS ports). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a UE in accordance with examples as disclosed herein. For example, the communications manager 1320 may be configured as or otherwise support a means for receiving, from a base station, first control signaling indicating a first FD-OCC sequence length of a set of multiple FD-OCC sequence lengths associated with wireless communications with the base station. The communications manager 1320 may be configured as or otherwise support a means for receiving, from the base station, second control signaling including an indication of a first antenna port value of a set of multiple antenna port values for wireless communications between the UE and the base station. The communications manager 1320 may be configured as or otherwise support a means for transmitting, to the base station, at least one DMRS via at least one antenna port of a set of multiple orthogonal antenna ports identified based on the first FD-OCC sequence length and the first antenna port value.

By including or configuring the communications manager 1320 in accordance with examples as described herein, the device 1305 may enable wireless communications using higher quantities of orthogonal DMRS ports. In particular, signaling and other configurations described herein may enable wireless communications systems 100 to increase a sequence length of supported FD-OCCs, thereby increasing a quantity of available orthogonal DMRS ports for supporting a higher number of spatial layers for uplink transmissions. As such, by enabling higher quantities of spatial layers for wireless communications, techniques described herein may enable higher quantities of wireless devices (e.g., UEs 115) to perform multiplexed communications within the same frequency resources, thereby improving spectral efficiency within the wireless communications system 100.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for increased quantities of orthogonal DMRS ports as described herein, or the processor 1340 and the memory 1330 may be otherwise configured to perform or support such operations.

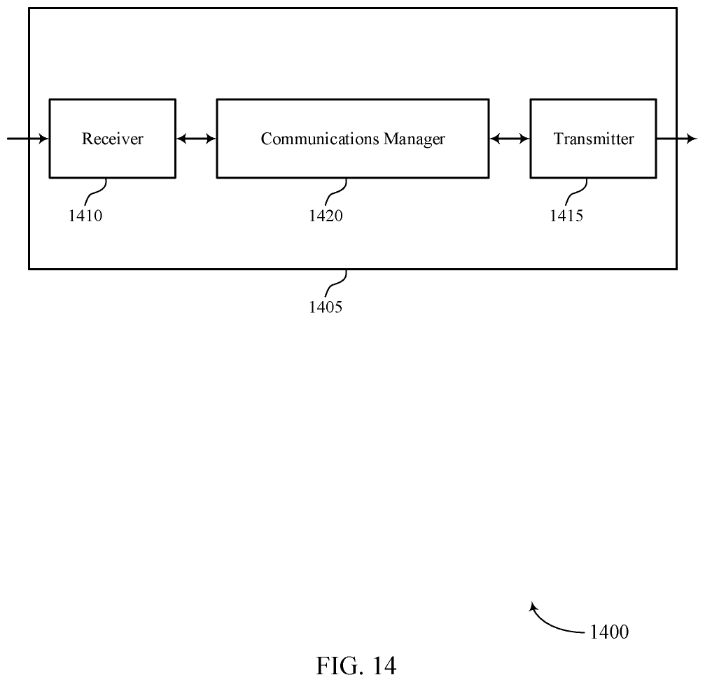

FIG. 14 shows a block diagram 1400 of a device 1405 that supports techniques for increased quantities of orthogonal DMRS ports in accordance with aspects of the present disclosure. The device 1405 may be an example of aspects of a base station 105 as described herein. The device 1405 may include a receiver 1410, a transmitter 1415, and a communications manager 1420. The device 1405 may also include a one or more processors, memory coupled with the one or more processors, and instructions stored in the memory that are executable by the one or more processors to enable the one or more processors to enable increased quantities of orthogonal DMRS ports, as discussed herein . . . . Each of these components may be in communication with one another (e.g., via one or more buses).

The receiver 1410 may provide a means for receiving information such as packets, user data, control information, or any combination thereof associated with various information channels (e.g., control channels, data channels, information channels related to techniques for increased quantities of orthogonal DMRS ports). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to techniques for increased quantities of orthogonal DMRS ports). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of techniques for increased quantities of orthogonal DMRS ports as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1420 may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a base station in accordance with examples as disclosed herein. For example, the communications manager 1420 may be configured as or otherwise support a means for transmitting, to a UE, first control signaling indicating a first FD-OCC sequence length of a set of multiple FD-OCC sequence lengths associated with wireless communications with the base station. The communications manager 1420 may be configured as or otherwise support a means for transmitting, to the UE, second control signaling including an indication of a first antenna port value of a set of multiple antenna port values for wireless communications between the UE and the base station. The communications manager 1420 may be configured as or otherwise support a means for receiving, from the base station, at least one DMRS via at least one antenna port of a set of multiple orthogonal antenna ports identified based on the first FD-OCC sequence length and the first antenna port value.

By including or configuring the communications manager 1420 in accordance with examples as described herein, the device 1405 (e.g., a processor controlling or otherwise coupled to the receiver 1410, the transmitter 1415, the communications manager 1420, or a combination thereof) may enable wireless communications using higher quantities of orthogonal DMRS ports. In particular, signaling and other configurations described herein may enable wireless communications systems 100 to increase a sequence length of supported FD-OCCs, thereby increasing a quantity of available orthogonal DMRS ports for supporting a higher number of spatial layers for uplink transmissions. As such, by enabling higher quantities of spatial layers for wireless communications, techniques described herein may enable higher quantities of wireless devices (e.g., UEs 115) to perform multiplexed communications within the same frequency resources, thereby improving spectral efficiency within the wireless communications system 100.

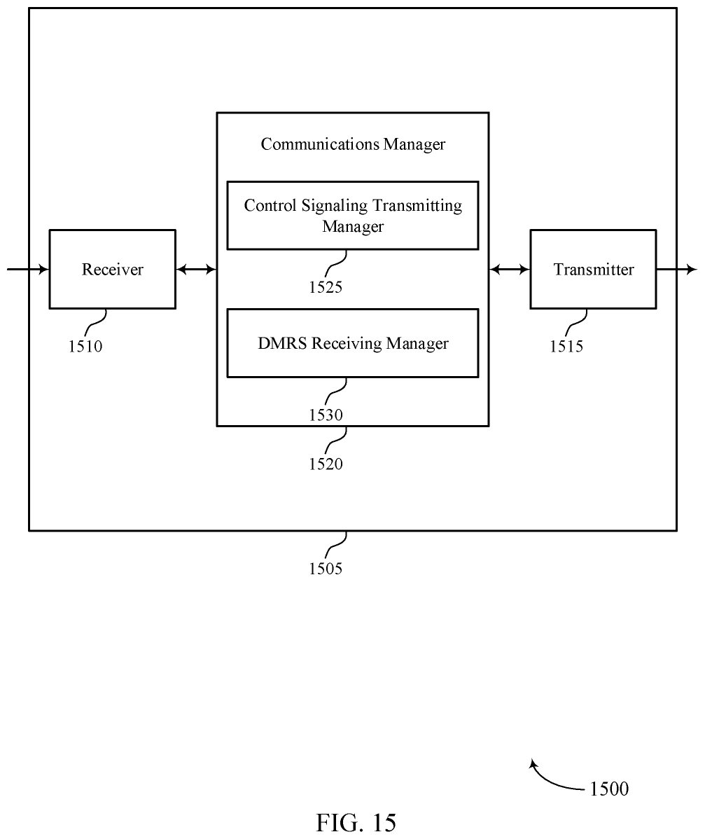

FIG. 15 shows a block diagram 1500 of a device 1505 that supports techniques for increased quantities of orthogonal DMRS ports in accordance with aspects of the present disclosure. The device 1505 may be an example of aspects of a device 1405 or a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to techniques for increased quantities of orthogonal DMRS ports). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to techniques for increased quantities of orthogonal DMRS ports). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of techniques for increased quantities of orthogonal DMRS ports as described herein. For example, the communications manager 1520 may include a control signaling transmitting manager 1525 a DMRS receiving manager 1530, or any combination thereof. The communications manager 1520 may be an example of aspects of a communications manager 1420 as described herein. In some examples, the communications manager 1520, or various components thereof, may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a base station in accordance with examples as disclosed herein. The control signaling transmitting manager 1525 may be configured as or otherwise support a means for transmitting, to a UE, first control signaling indicating a first FD-OCC sequence length of a set of multiple FD-OCC sequence lengths associated with wireless communications with the base station. The control signaling transmitting manager 1525 may be configured as or otherwise support a means for transmitting, to the UE, second control signaling including an indication of a first antenna port value of a set of multiple antenna port values for wireless communications between the UE and the base station. The DMRS receiving manager 1530 may be configured as or otherwise support a means for receiving, from the base station, at least one DMRS via at least one antenna port of a set of multiple orthogonal antenna ports identified based on the first FD-OCC sequence length and the first antenna port value.

In some cases, the control signaling transmitting manager 1525 and the DMRS receiving manager 1230 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling transmitting manager 1525 and the DMRS receiving manager 1230 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

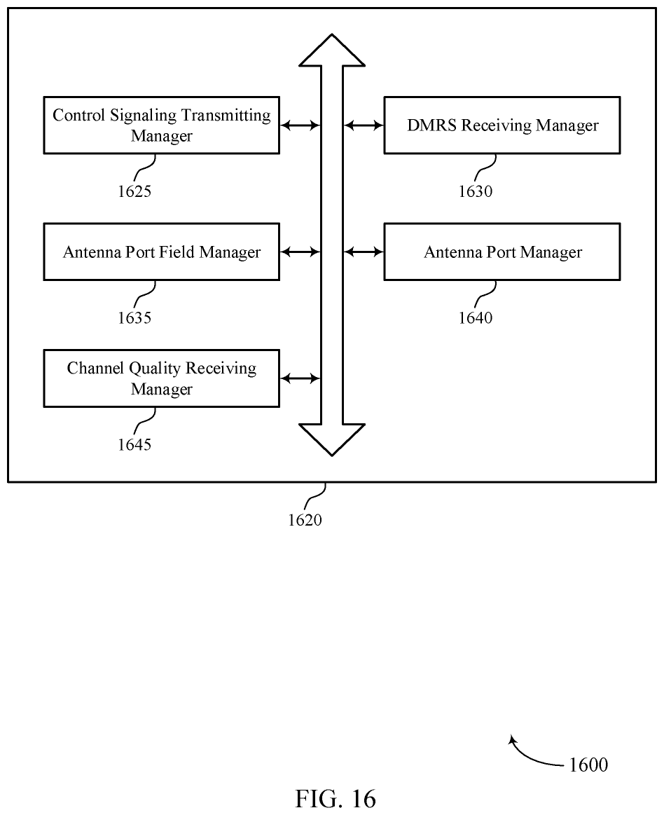

FIG. 16 shows a block diagram 1600 of a communications manager 1620 that supports techniques for increased quantities of orthogonal DMRS ports in accordance with aspects of the present disclosure. The communications manager 1620 may be an example of aspects of a communications manager 1420, a communications manager 1520, or both, as described herein. The communications manager 1620, or various components thereof, may be an example of means for performing various aspects of techniques for increased quantities of orthogonal DMRS ports as described herein. For example, the communications manager 1620 may include a control signaling transmitting manager 1625, a DMRS receiving manager 1630, an antenna port field manager 1635, an antenna port manager 1640, a channel quality receiving manager 1645, or any combination thereof. Each of these components may communicate, directly or indirectly, with one another (e.g., via one or more buses).

The communications manager 1620 may support wireless communication at a base station in accordance with examples as disclosed herein. The control signaling transmitting manager 1625 may be configured as or otherwise support a means for transmitting, to a UE, first control signaling indicating a first FD-OCC sequence length of a set of multiple FD-OCC sequence lengths associated with wireless communications with the base station. In some examples, the control signaling transmitting manager 1625 may be configured as or otherwise support a means for transmitting, to the UE, second control signaling including an indication of a first antenna port value of a set of multiple antenna port values for wireless communications between the UE and the base station. The DMRS receiving manager 1630 may be configured as or otherwise support a means for receiving, from the base station, at least one DMRS via at least one antenna port of a set of multiple orthogonal antenna ports identified based on the first FD-OCC sequence length and the first antenna port value.

In some examples, the control signaling transmitting manager 1625 may be configured as or otherwise support a means for transmitting, via the second control signaling, one or more antenna port field values including the indication of the first antenna port value, the first antenna port value associated with a subset of antenna ports of the set of multiple antenna ports, the subset of antenna ports including the at least one antenna port. In some examples, the antenna port field manager 1635 may be configured as or otherwise support a means for transmitting, to the UE based on the one or more antenna port field values, an indication of the at least one antenna port included within the subset of antenna ports, where receiving the at least one DMRS is based on the indication of the at least one antenna port.

In some examples, the control signaling transmitting manager 1625 may be configured as or otherwise support a means for transmitting the indication of the at least one antenna port of the subset of antenna ports via the first control signaling, third control signaling, or both. In some examples, the control signaling transmitting manager 1625 may be configured as or otherwise support a means for transmitting the indication of the at least one antenna port of the subset of antenna ports via one or more additional field values included within the second control signaling. In some examples, the one or more additional field values include a TDRA field value, a FDRA field value, a sounding reference signal CS field value, or any combination thereof.

In some examples, the antenna port field manager 1635 may be configured as or otherwise support a means for transmitting, via the second control signaling, a set of multiple antenna port field values including the indication of the first antenna port value, the set of multiple antenna port field values including four or more antenna port field values.

In some examples, the control signaling transmitting manager 1625 may be configured as or otherwise support a means for transmitting, via the first control signaling or additional control signaling, an activation of at least one antenna port field value of the set of multiple antenna port field values, where transmitting the indication of the first antenna port value is based on the activation of the at least one antenna port field value.

In some examples, the control signaling transmitting manager 1625 may be configured as or otherwise support a means for transmitting, via the first control signaling, the second control signaling, additional control signaling, or any combination thereof, an indication of a rank associated with wireless communications between the UE and the base station. In some examples, the control signaling transmitting manager 1625 may be configured as or otherwise support a means for transmitting, via the second control signaling, a set of multiple antenna port field values including the indication of the first antenna port value. In some examples, the antenna port manager 1640 may be configured as or otherwise support a means for identifying the at least one antenna port based on the set of multiple antenna port field values and the rank.

In some examples, the antenna port manager 1640 may be configured as or otherwise support a means for identifying one or more additional antenna ports of the set of multiple antenna ports based on the set of multiple antenna port field values and the rank, where receiving the at least one DMRS is based on the one or more additional antenna ports.

In some examples, the antenna port field manager 1635 may be configured as or otherwise support a means for identifying a set of CS values, a Walsh sequence, or both, associated with wireless communications between the UE and the base station based on the indication of the first antenna port value. In some examples, the antenna port manager 1640 may be configured as or otherwise support a means for identifying the at least one antenna port of the set of multiple antenna ports in accordance with the set of CS values, the Walsh sequence, or both.

In some examples, the control signaling transmitting manager 1625 may be configured as or otherwise support a means for transmitting, to the UE, third control signaling indicating a second FD-OCC sequence length of the set of multiple FD-OCC sequence lengths associated with wireless communications with the base station, the second FD-OCC sequence length different from the first FD-OCC sequence length. In some examples, the control signaling transmitting manager 1625 may be configured as or otherwise support a means for receiving, from the base station, fourth control signaling including an indication of a second antenna port value of the set of multiple antenna port values for wireless communications between the UE and the base station. In some examples, the DMRS receiving manager 1630 may be configured as or otherwise support a means for transmitting, to the base station, at least one additional DMRS via at least one additional antenna port of the set of multiple orthogonal antenna ports identified based on the second FD-OCC sequence length and the second antenna port value.

In some examples, the channel quality receiving manager 1645 may be configured as or otherwise support a means for receiving, from the UE, an indication of a channel quality associated with a channel between the UE and the base station, where transmitting the third control signaling, transmitting the fourth control signaling, or both, is based at least in a part on receiving the indication of the channel quality.

In some examples, the first FD-OCC sequence length is greater than two. In some examples, the first FD-OCC sequence length is based on an SCS associated with wireless communications between the UE and the base station, a quantity of frequency combs associated with wireless communications between the UE and the base station, or both. In some examples, the first control signaling includes an RRC message, a MAC-CE message, or both. In some examples, the second control signaling includes a DCI message. In some examples, a first subset of the set of multiple orthogonal antenna ports are orthogonal to a second subset of the set of multiple orthogonal antenna ports.

In some cases, the control signaling transmitting manager 1625, the DMRS receiving manager 1630, the antenna port field manager 1635, the antenna port manager 1640, and the channel quality receiving manger 1645 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling transmitting manager 1625, the DMRS receiving manager 1630, the antenna port field manager 1635, the antenna port manager 1640, and the channel quality receiving manger 1645 discussed herein.

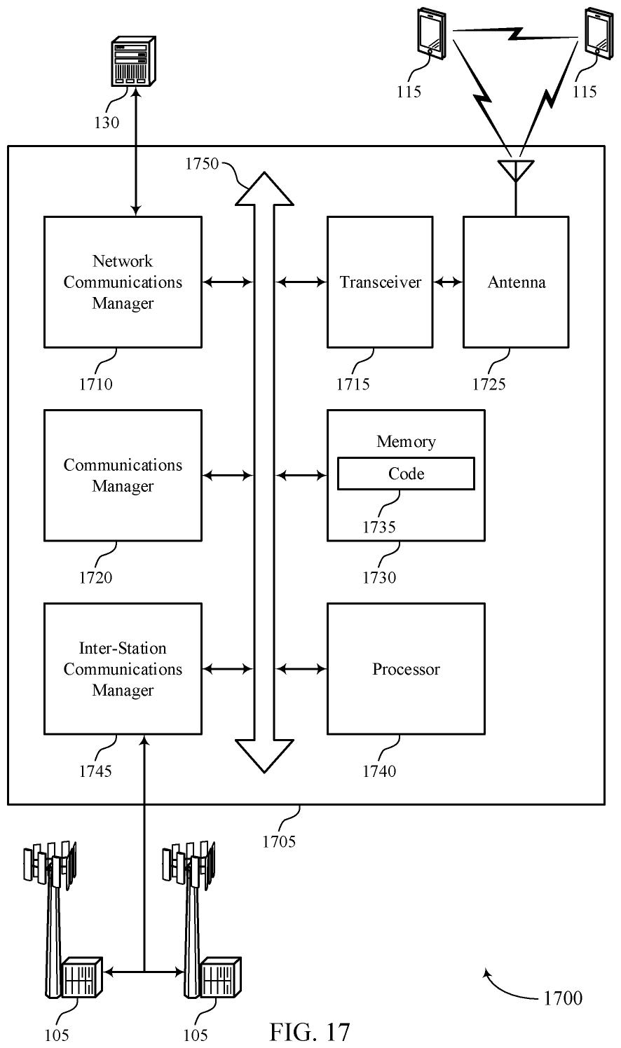

FIG. 17 shows a diagram of a system 1700 including a device 1705 that supports techniques for increased quantities of orthogonal DMRS ports in accordance with aspects of the present disclosure. The device 1705 may be an example of or include the components of a device 1405, a device 1505, or a base station 105 as described herein. The device 1705 may communicate wirelessly with one or more base stations 105, UEs 115, or any combination thereof. The device 1705 may include components for bi-directional voice and data communications including components for transmitting and receiving communications, such as a communications manager 1720, a network communications manager 1710, a transceiver 1715, an antenna 1725, a memory 1730, code 1735, a processor 1740, and an inter-station communications manager 1745. These components may be in electronic communication or otherwise coupled (e.g., operatively, communicatively, functionally, electronically, electrically) via one or more buses (e.g., a bus 1750).

The network communications manager 1710 may manage communications with a core network 130 (e.g., via one or more wired backhaul links). For example, the network communications manager 1710 may manage the transfer of data communications for client devices, such as one or more UEs 115.

In some cases, the device 1705 may include a single antenna 1725. However, in some other cases the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The memory 1730 may include RAM and ROM. The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a BIOS which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting techniques for increased quantities of orthogonal DMRS ports). For example, the device 1705 or a component of the device 1705 may include a processor 1740 and memory 1730 coupled to the processor 1740, the processor 1740 and memory 1730 configured to perform various functions described herein.

The inter-station communications manager 1745 may manage communications with other base stations 105, and may include a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communications network technology to provide communication between base stations 105.

The communications manager 1720 may support wireless communication at a base station in accordance with examples as disclosed herein. For example, the communications manager 1720 may be configured as or otherwise support a means for transmitting, to a UE, first control signaling indicating a first FD-OCC sequence length of a set of multiple FD-OCC sequence lengths associated with wireless communications with the base station. The communications manager 1720 may be configured as or otherwise support a means for transmitting, to the UE, second control signaling including an indication of a first antenna port value of a set of multiple antenna port values for wireless communications between the UE and the base station. The communications manager 1720 may be configured as or otherwise support a means for receiving, from the base station, at least one DMRS via at least one antenna port of a set of multiple orthogonal antenna ports identified based on the first FD-OCC sequence length and the first antenna port value.

By including or configuring the communications manager 1720 in accordance with examples as described herein, the device 1705 may enable wireless communications using higher quantities of orthogonal DMRS ports. In particular, signaling and other configurations described herein may enable wireless communications systems 100 to increase a sequence length of supported FD-OCCs, thereby increasing a quantity of available orthogonal DMRS ports for supporting a higher number of spatial layers for uplink transmissions. As such, by enabling higher quantities of spatial layers for wireless communications, techniques described herein may enable higher quantities of wireless devices (e.g., UEs 115) to perform multiplexed communications within the same frequency resources, thereby improving spectral efficiency within the wireless communications system 100.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of techniques for increased quantities of orthogonal DMRS ports as described herein, or the processor 1740 and the memory 1730 may be otherwise configured to perform or support such operations.

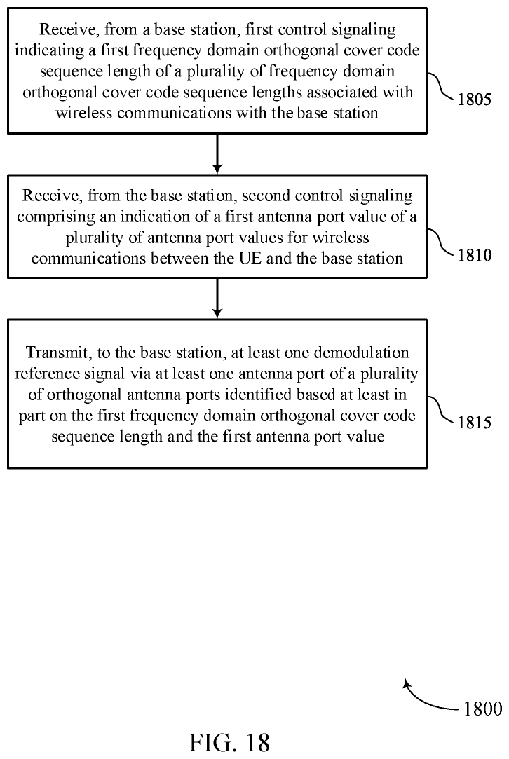

FIG. 18 shows a flowchart illustrating a method 1800 that supports techniques for increased quantities of orthogonal DMRS ports in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, first control signaling indicating a first FD-OCC sequence length of a set of multiple FD-OCC sequence lengths associated with wireless communications with the base station. The operations of 1805 may be performed in accordance with examples as disclosed herein. In some examples, aspects of the operations of 1805 may be performed by a control signaling receiving manager 1225 as described with reference to FIG. 12.

At 1810, the method may include receiving, from the base station, second control signaling including an indication of a first antenna port value of a set of multiple antenna port values for wireless communications between the UE and the base station. The operations of 1810 may be performed in accordance with examples as disclosed herein. In some examples, aspects of the operations of 1810 may be performed by a control signaling receiving manager 1225 as described with reference to FIG. 12.

At 1815, the method may include transmitting, to the base station, at least one DMRS via at least one antenna port of a set of multiple orthogonal antenna ports identified based on the first FD-OCC sequence length and the first antenna port value. The operations of 1815 may be performed in accordance with examples as disclosed herein. In some examples, aspects of the operations of 1815 may be performed by a DMRS transmitting manager 1230 as described with reference to FIG. 12.

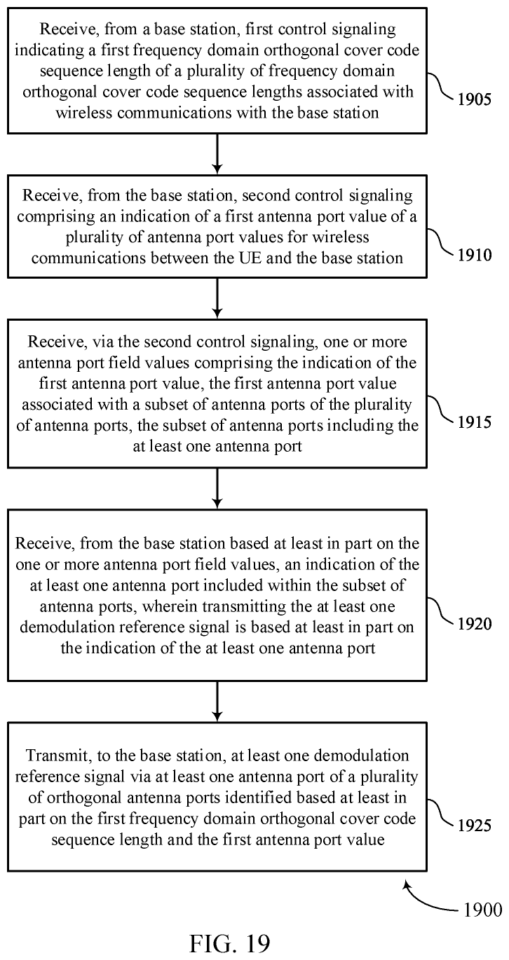

FIG. 19 shows a flowchart illustrating a method 1900 that supports techniques for increased quantities of orthogonal DMRS ports in accordance with aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, first control signaling indicating a first FD-OCC sequence length of a set of multiple FD-OCC sequence lengths associated with wireless communications with the base station. The operations of 1905 may be performed in accordance with examples as disclosed herein.

In some examples, aspects of the operations of 1905 may be performed by a control signaling receiving manager 1225 as described with reference to FIG. 12.

At 1910, the method may include receiving, from the base station, second control signaling including an indication of a first antenna port value of a set of multiple antenna port values for wireless communications between the UE and the base station. The operations of 1910 may be performed in accordance with examples as disclosed herein. In some examples, aspects of the operations of 1910 may be performed by a control signaling receiving manager 1225 as described with reference to FIG. 12.

At 1915, the method may include receiving, via the second control signaling, one or more antenna port field values including the indication of the first antenna port value, the first antenna port value associated with a subset of antenna ports of the set of multiple antenna ports, the subset of antenna ports including the at least one antenna port. The operations of 1915 may be performed in accordance with examples as disclosed herein. In some examples, aspects of the operations of 1915 may be performed by a control signaling receiving manager 1225 as described with reference to FIG. 12.

At 1920, the method may include receiving, from the base station based on the one or more antenna port field values, an indication of the at least one antenna port included within the subset of antenna ports, where transmitting the at least one DMRS is based on the indication of the at least one antenna port. The operations of 1920 may be performed in accordance with examples as disclosed herein. In some examples, aspects of the operations of 1920 may be performed by an antenna port field manager 1235 as described with reference to FIG. 12.

At 1925, the method may include transmitting, to the base station, at least one DMRS via at least one antenna port of a set of multiple orthogonal antenna ports identified based on the first FD-OCC sequence length and the first antenna port value. The operations of 1925 may be performed in accordance with examples as disclosed herein. In some examples, aspects of the operations of 1925 may be performed by a DMRS transmitting manager 1230 as described with reference to FIG. 12.

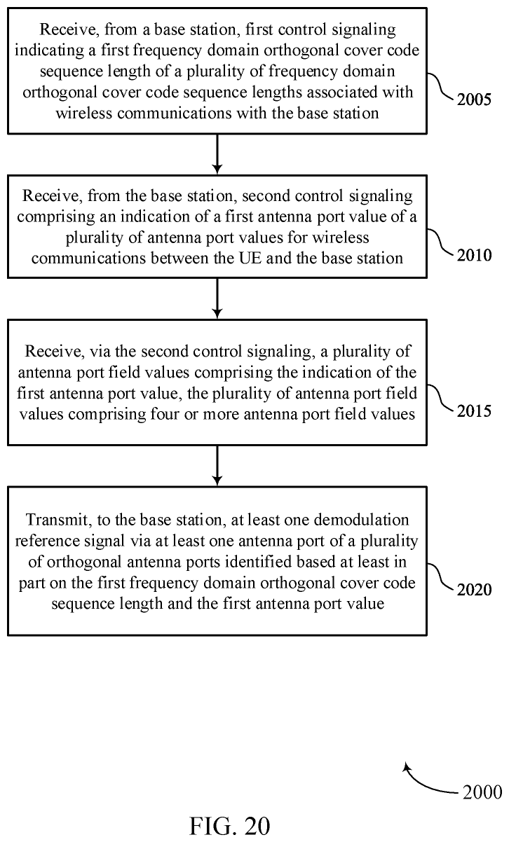

FIG. 20 shows a flowchart illustrating a method 2000 that supports techniques for increased quantities of orthogonal DMRS ports in accordance with aspects of the present disclosure. The operations of the method 2000 may be implemented by a UE or its components as described herein. For example, the operations of the method 2000 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 2005, the method may include receiving, from a base station, first control signaling indicating a first FD-OCC sequence length of a set of multiple FD-OCC sequence lengths associated with wireless communications with the base station. The operations of 2005 may be performed in accordance with examples as disclosed herein. In some examples, aspects of the operations of 2005 may be performed by a control signaling receiving manager 1225 as described with reference to FIG. 12.

At 2010, the method may include receiving, from the base station, second control signaling including an indication of a first antenna port value of a set of multiple antenna port values for wireless communications between the UE and the base station. The operations of 2010 may be performed in accordance with examples as disclosed herein. In some examples, aspects of the operations of 2010 may be performed by a control signaling receiving manager 1225 as described with reference to FIG. 12.

At 2015, the method may include receiving, via the second control signaling, a set of multiple antenna port field values including the indication of the first antenna port value, the set of multiple antenna port field values including four or more antenna port field values. The operations of 2015 may be performed in accordance with examples as disclosed herein. In some examples, aspects of the operations of 2015 may be performed by a control signaling receiving manager 1225 as described with reference to FIG. 12.

At 2020, the method may include transmitting, to the base station, at least one DMRS via at least one antenna port of a set of multiple orthogonal antenna ports identified based on the first FD-OCC sequence length and the first antenna port value. The operations of 2020 may be performed in accordance with examples as disclosed herein. In some examples, aspects of the operations of 2020 may be performed by a DMRS transmitting manager 1230 as described with reference to FIG. 12.

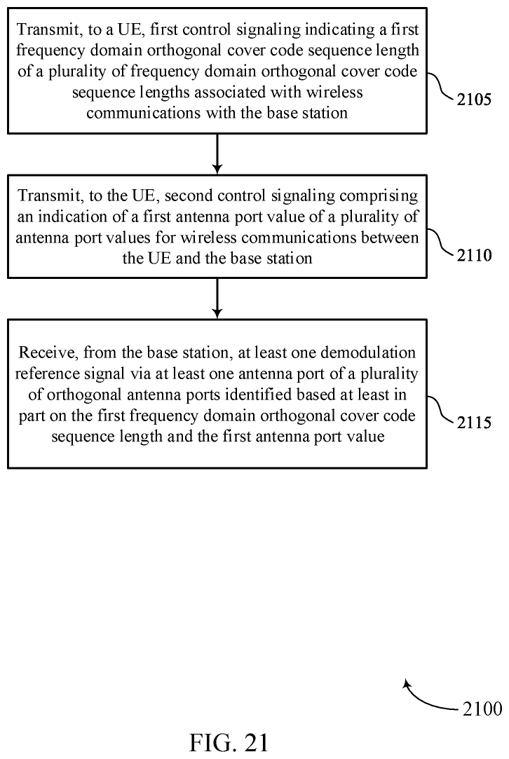

FIG. 21 shows a flowchart illustrating a method 2100 that supports techniques for increased quantities of orthogonal DMRS ports in accordance with aspects of the present disclosure. The operations of the method 2100 may be implemented by a base station or its components as described herein. For example, the operations of the method 2100 may be performed by a base station 105 as described with reference to FIGS. 1 through 9 and 14 through 17. In some examples, a base station may execute a set of instructions to control the functional elements of the base station to perform the described functions. Additionally or alternatively, the base station may perform aspects of the described functions using special-purpose hardware.

At 2105, the method may include transmitting, to a UE, first control signaling indicating a first FD-OCC sequence length of a set of multiple FD-OCC sequence lengths associated with wireless communications with the base station. The operations of 2105 may be performed in accordance with examples as disclosed herein. In some examples, aspects of the operations of 2105 may be performed by a control signaling transmitting manager 1625 as described with reference to FIG. 16.

At 2110, the method may include transmitting, to the UE, second control signaling including an indication of a first antenna port value of a set of multiple antenna port values for wireless communications between the UE and the base station. The operations of 2110 may be performed in accordance with examples as disclosed herein. In some examples, aspects of the operations of 2110 may be performed by a control signaling transmitting manager 1625 as described with reference to FIG. 16.

At 2115, the method may include receiving, from the base station, at least one DMRS via at least one antenna port of a set of multiple orthogonal antenna ports identified based on the first FD-OCC sequence length and the first antenna port value. The operations of 2115 may be performed in accordance with examples as disclosed herein. In some examples, aspects of the operations of 2115 may be performed by a DMRS receiving manager 1630 as described with reference to FIG. 16.

The following provides an overview of aspects of the present disclosure:

Aspect 1: A method for wireless communication at a UE, comprising: receiving, from a base station, first control signaling indicating a first FD-OCC sequence length of a plurality of FD-OCC sequence lengths associated with wireless communications with the base station; receiving, from the base station, second control signaling comprising an indication of a first antenna port value of a plurality of antenna port values for wireless communications between the UE and the base station; and transmitting, to the base station, at least one DMRS via at least one antenna port of a plurality of orthogonal antenna ports identified based at least in part on the first FD-OCC sequence length and the first antenna port value.

Aspect 2: The method of aspect 1, further comprising: receiving, via the second control signaling, one or more antenna port field values comprising the indication of the first antenna port value, the first antenna port value associated with a subset of antenna ports of the plurality of antenna ports, the subset of antenna ports including the at least one antenna port; and receiving, from the base station based at least in part on the one or more antenna port field values, an indication of the at least one antenna port included within the subset of antenna ports, wherein transmitting the at least one DMRS is based at least in part on the indication of the at least one antenna port.

Aspect 3: The method of aspect 2, further comprising: receiving the indication of the at least one antenna port of the subset of antenna ports via the first control signaling, third control signaling, or both.

Aspect 4: The method of any of aspects 2 through 3, further comprising: receiving the indication of the at least one antenna port of the subset of antenna ports via one or more additional field values included within the second control signaling.

Aspect 5: The method of aspect 4, wherein the one or more additional field values comprise a TDRA field value, a FDRA field value, a SRS CS field value, or any combination thereof.

Aspect 6: The method of any of aspects 1 through 5, further comprising: receiving, via the second control signaling, a plurality of antenna port field values comprising the indication of the first antenna port value, the plurality of antenna port field values comprising four or more antenna port field values.

Aspect 7: The method of aspect 6, further comprising: receiving, via the first control signaling or additional control signaling, an activation of at least one antenna port field value of the plurality of antenna port field values, wherein receiving the indication of the first antenna port value is based at least in part on the activation of the at least one antenna port field value.

Aspect 8: The method of any of aspects 1 through 7, further comprising: receiving, via the first control signaling, the second control signaling, additional control signaling, or any combination thereof, an indication of a rank associated with wireless communications between the UE and the base station; receiving, via the second control signaling, a plurality of antenna port field values comprising the indication of the first antenna port value; and identifying the at least one antenna port based at least in part on the plurality of antenna port field values and the rank.

Aspect 9: The method of aspect 8, further comprising: identifying one or more additional antenna ports of the plurality of antenna ports based at least in part on the plurality of antenna port field values and the rank, wherein transmitting the at least one DMRS is based at least in part on the one or more additional antenna ports.

Aspect 10: The method of any of aspects 1 through 9, further comprising: identifying a set of CS values, a Walsh sequence, or both, associated with wireless communications between the UE and the base station based at least in part on the indication of the first antenna port value; and identifying the at least one antenna port of the plurality of antenna ports in accordance with the set of CS values, the Walsh sequence, or both.

Aspect 11: The method of any of aspects 1 through 10, further comprising: receiving, from the base station, third control signaling indicating a second FD-OCC sequence length of the plurality of FD-OCC sequence lengths associated with wireless communications with the base station, the second FD-OCC sequence length different from the first FD-OCC sequence length; receiving, from the base station, fourth control signaling comprising an indication of a second antenna port value of the plurality of antenna port values for wireless communications between the UE and the base station; transmitting, to the base station, at least one additional DMRS via at least one additional antenna port of the plurality of orthogonal antenna ports identified based at least in part on the second FD-OCC sequence length and the second antenna port value.

Aspect 12: The method of aspect 11, further comprising: transmitting, to the base station, an indication of a channel quality associated with a channel between the UE and the base station, wherein receiving the third control signaling, receiving the fourth control signaling, or both, is based at least in a part on transmitting the indication of the channel quality.

Aspect 13: The method of any of aspects 1 through 12, wherein the first FD-OCC sequence length is greater than two.

Aspect 14: The method of any of aspects 1 through 13, wherein the first FD-OCC sequence length is based at least in part on an SCS associated with wireless communications between the UE and the base station, a quantity of frequency combs associated with wireless communications between the UE and the base station, or both.

Aspect 15: The method of any of aspects 1 through 14, wherein the first control signaling comprises an RRC message, a MAC-CE message, or both, and the second control signaling comprises a DCI message.

Aspect 16: The method of any of aspects 1 through 15, wherein a first subset of the plurality of orthogonal antenna ports are orthogonal to a second subset of the plurality of orthogonal antenna ports.

Aspect 17: A method for wireless communication at a base station, comprising: transmitting, to a UE, first control signaling indicating a first FD-OCC sequence length of a plurality of FD-OCC sequence lengths associated with wireless communications with the base station; transmitting, to the UE, second control signaling comprising an indication of a first antenna port value of a plurality of antenna port values for wireless communications between the UE and the base station; and receiving, from the base station, at least one DMRS via at least one antenna port of a plurality of orthogonal antenna ports identified based at least in part on the first FD-OCC sequence length and the first antenna port value.

Aspect 18: The method of aspect 17, further comprising: transmitting, via the second control signaling, one or more antenna port field values comprising the indication of the first antenna port value, the first antenna port value associated with a subset of antenna ports of the plurality of antenna ports, the subset of antenna ports including the at least one antenna port; and transmitting, to the UE based at least in part on the one or more antenna port field values, an indication of the at least one antenna port included within the subset of antenna ports, wherein receiving the at least one DMRS is based at least in part on the indication of the at least one antenna port.

Aspect 19: The method of aspect 18, further comprising: transmitting the indication of the at least one antenna port of the subset of antenna ports via the first control signaling, third control signaling, or both.

Aspect 20: The method of any of aspects 18 through 19, further comprising: transmitting the indication of the at least one antenna port of the subset of antenna ports via one or more additional field values included within the second control signaling.

Aspect 21: The method of aspect 20, wherein the one or more additional field values comprise a TDRA field value, a FDRA field value, a SRS CS field value, or any combination thereof.

Aspect 22: The method of any of aspects 17 through 21, further comprising: transmitting, via the second control signaling, a plurality of antenna port field values comprising the indication of the first antenna port value, the plurality of antenna port field values comprising four or more antenna port field values.

Aspect 23: The method of aspect 22, further comprising: transmitting, via the first control signaling or additional control signaling, an activation of at least one antenna port field value of the plurality of antenna port field values, wherein transmitting the indication of the first antenna port value is based at least in part on the activation of the at least one antenna port field value.

Aspect 24: The method of any of aspects 17 through 23, further comprising: transmitting, via the first control signaling, the second control signaling, additional control signaling, or any combination thereof, an indication of a rank associated with wireless communications between the UE and the base station; transmitting, via the second control signaling, a plurality of antenna port field values comprising the indication of the first antenna port value; and identifying the at least one antenna port based at least in part on the plurality of antenna port field values and the rank.

Aspect 25: The method of aspect 24, further comprising: identifying one or more additional antenna ports of the plurality of antenna ports based at least in part on the plurality of antenna port field values and the rank, wherein receiving the at least one DMRS is based at least in part on the one or more additional antenna ports.

Aspect 26: The method of any of aspects 17 through 25, further comprising: identifying a set of CS values, a Walsh sequence, or both, associated with wireless communications between the UE and the base station based at least in part on the indication of the first antenna port value; and identifying the at least one antenna port of the plurality of antenna ports in accordance with the set of CS values, the Walsh sequence, or both.

Aspect 27: The method of any of aspects 17 through 26, further comprising: transmitting, to the UE, third control signaling indicating a second FD-OCC sequence length of the plurality of FD-OCC sequence lengths associated with wireless communications with the base station, the second FD-OCC sequence length different from the first FD-OCC sequence length; receiving, from the base station, fourth control signaling comprising an indication of a second antenna port value of the plurality of antenna port values for wireless communications between the UE and the base station; transmitting, to the base station, at least one additional DMRS via at least one additional antenna port of the plurality of orthogonal antenna ports identified based at least in part on the second FD-OCC sequence length and the second antenna port value.

Aspect 28: The method of aspect 27, further comprising: receiving, from the UE, an indication of a channel quality associated with a channel between the UE and the base station, wherein transmitting the third control signaling, transmitting the fourth control signaling, or both, is based at least in a part on receiving the indication of the channel quality.

Aspect 29: The method of any of aspects 17 through 28, wherein the first FD-OCC sequence length is greater than two.

Aspect 30: The method of any of aspects 17 through 29, wherein the first FD-OCC sequence length is based at least in part on an SCS associated with wireless communications between the UE and the base station, a quantity of frequency combs associated with wireless communications between the UE and the base station, or both.

Aspect 31: The method of any of aspects 17 through 30, wherein the first control signaling comprises an RRC message, a MAC-CE message, or both, and the second control signaling comprises a DCI message

Aspect 32: The method of any of aspects 17 through 31, wherein a first subset of the plurality of orthogonal antenna ports are orthogonal to a second subset of the plurality of orthogonal antenna ports.

Aspect 33: An apparatus for wireless communication at a UE, comprising a processor; memory coupled with the processor; and instructions stored in the memory and executable by the processor to cause the apparatus to perform a method of any of aspects 1 through 16.

Aspect 34: An apparatus for wireless communication at a UE, comprising at least one means for performing a method of any of aspects 1 through 16.

Aspect 35: A non-transitory computer-readable medium storing code for wireless communication at a UE, the code comprising instructions executable by a processor to perform a method of any of aspects 1 through 16.

Aspect 36: An apparatus for wireless communication at a base station, comprising a processor; memory coupled with the processor; and instructions stored in the memory and executable by the processor to cause the apparatus to perform a method of any of aspects 17 through 32.

Aspect 37: An apparatus for wireless communication at a base station, comprising at least one means for performing a method of any of aspects 17 through 32.

Aspect 38: A non-transitory computer-readable medium storing code for wireless communication at a base station, the code comprising instructions executable by a processor to perform a method of any of aspects 17 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, first control signaling indicating a first frequency domain orthogonal cover code sequence length of a plurality of frequency domain orthogonal cover code sequence lengths associated with wireless communications with the base station;
receiving, from the base station, second control signaling comprising an indication of a first antenna port value of a plurality of antenna port values for wireless communications between the UE and the base station; and
transmitting, to the base station, at least one demodulation reference signal via at least one antenna port of a plurality of orthogonal antenna ports identified based at least in part on the first frequency domain orthogonal cover code sequence length and the first antenna port value.

2. The method of claim 1, further comprising:
receiving, via the second control signaling, one or more antenna port field values comprising the indication of the first antenna port value, the first antenna port value associated with a subset of antenna ports of the plurality of antenna ports, the subset of antenna ports including the at least one antenna port; and
receiving, from the base station based at least in part on the one or more antenna port field values, an indication of the at least one antenna port included within the subset of antenna ports, wherein transmitting the at least one demodulation reference signal is based at least in part on the indication of the at least one antenna port.

3. The method of claim 2, further comprising:
receiving the indication of the at least one antenna port of the subset of antenna ports via the first control signaling, third control signaling, or both.

4. The method of claim 2, further comprising:
receiving the indication of the at least one antenna port of the subset of antenna ports via one or more additional field values included within the second control signaling.

5. The method of claim 4, wherein the one or more additional field values comprise a time domain resource allocation field value, a frequency domain resource allocation field value, a sounding reference signal cyclic shift field value, or any combination thereof.

6. The method of claim 1, further comprising:
receiving, via the second control signaling, a plurality of antenna port field values comprising the indication of the first antenna port value, the plurality of antenna port field values comprising four or more antenna port field values.

7. The method of claim 6, further comprising:
receiving, via the first control signaling or additional control signaling, an activation of at least one antenna port field value of the plurality of antenna port field values, wherein receiving the indication of the first antenna port value is based at least in part on the activation of the at least one antenna port field value.

8. The method of claim 1, further comprising:
receiving, via the first control signaling, the second control signaling, additional control signaling, or any combination thereof, an indication of a rank associated with wireless communications between the UE and the base station;
receiving, via the second control signaling, a plurality of antenna port field values comprising the indication of the first antenna port value; and
identifying the at least one antenna port based at least in part on the plurality of antenna port field values and the rank.

9. The method of claim 8, further comprising:
identifying one or more additional antenna ports of the plurality of antenna ports based at least in part on the plurality of antenna port field values and the rank, wherein transmitting the at least one demodulation reference signal is based at least in part on the one or more additional antenna ports.

10. The method of claim 1, further comprising:
identifying a set of cyclic shift values, a Walsh sequence, or both, associated with wireless communications between the UE and the base station based at least in part on the indication of the first antenna port value; and
identifying the at least one antenna port of the plurality of antenna ports in accordance with the set of cyclic shift values, the Walsh sequence, or both.

11. The method of claim 1, further comprising:
receiving, from the base station, third control signaling indicating a second frequency domain orthogonal cover code sequence length of the plurality of frequency domain orthogonal cover code sequence lengths associated with wireless communications with the base station, the second frequency domain orthogonal cover code sequence length different from the first frequency domain orthogonal cover code sequence length;
receiving, from the base station, fourth control signaling comprising an indication of a second antenna port value of the plurality of antenna port values for wireless communications between the UE and the base station;
transmitting, to the base station, at least one additional demodulation reference signal via at least one additional antenna port of the plurality of orthogonal antenna ports identified based at least in part on the second frequency domain orthogonal cover code 12 sequence length and the second antenna port value.

12. The method of claim 11, further comprising:
transmitting, to the base station, an indication of a channel quality associated with a channel between the UE and the base station, wherein receiving the third control signaling, receiving the fourth control signaling, or both, is based at least in a part on transmitting the indication of the channel quality.

13. The method of claim 1, wherein the first frequency domain orthogonal cover code sequence length is greater than two.

14. The method of claim 1, wherein the first frequency domain orthogonal cover code sequence length is based at least in part on a subcarrier spacing associated with wireless communications between the UE and the base station, a quantity of frequency combs associated with wireless communications between the UE and the base station, or both.

15. The method of claim 1, wherein the first control signaling comprises a radio resource control message, a medium access control-control element message, or both, and wherein the second control signaling comprises a downlink control information message.

16. The method of claim 1, wherein a first subset of the plurality of orthogonal antenna ports are orthogonal to a second subset of the plurality of orthogonal antenna ports.

17. A method for wireless communication at a base station, comprising:
transmitting, to a user equipment (UE), first control signaling indicating a first frequency domain orthogonal cover code sequence length of a plurality of frequency domain orthogonal cover code sequence lengths associated with wireless communications with the base station;
transmitting, to the UE, second control signaling comprising an indication of a first antenna port value of a plurality of antenna port values for wireless communications between the UE and the base station; and
receiving, from the base station, at least one demodulation reference signal via at least one antenna port of a plurality of orthogonal antenna ports identified based at least in part on the first frequency domain orthogonal cover code sequence length and the first 11 antenna port value.

18. The method of claim 17, further comprising:
transmitting, via the second control signaling, one or more antenna port field values comprising the indication of the first antenna port value, the first antenna port value associated with a subset of antenna ports of the plurality of antenna ports, the subset of antenna ports including the at least one antenna port; and
transmitting, to the UE based at least in part on the one or more antenna port field values, an indication of the at least one antenna port included within the subset of antenna ports, wherein receiving the at least one demodulation reference signal is based at least in part on the indication of the at least one antenna port.

19. The method of claim 18, further comprising:
transmitting the indication of the at least one antenna port of the subset of antenna ports via the first control signaling, third control signaling, or both.

20. The method of claim 18, further comprising:
transmitting the indication of the at least one antenna port of the subset of antenna ports via one or more additional field values included within the second control signaling.

21. The method of claim 20, wherein the one or more additional field values comprise a time domain resource allocation field value, a frequency domain resource allocation field value, a sounding reference signal cyclic shift field value, or any combination thereof.

22. The method of claim 17, further comprising:
transmitting, via the second control signaling, a plurality of antenna port field values comprising the indication of the first antenna port value, the plurality of antenna port field values comprising four or more antenna port field values.

23. The method of claim 22, further comprising:
transmitting, via the first control signaling or additional control signaling, an activation of at least one antenna port field value of the plurality of antenna port field values, wherein transmitting the indication of the first antenna port value is based at least in part on the activation of the at least one antenna port field value.

24. The method of claim 17, further comprising:
transmitting, via the first control signaling, the second control signaling, additional control signaling, or any combination thereof, an indication of a rank associated with wireless communications between the UE and the base station;
transmitting, via the second control signaling, a plurality of antenna port field values comprising the indication of the first antenna port value; and
identifying the at least one antenna port based at least in part on the plurality of antenna port field values and the rank.

25. The method of claim 24, further comprising:
identifying one or more additional antenna ports of the plurality of antenna ports based at least in part on the plurality of antenna port field values and the rank, wherein receiving the at least one demodulation reference signal is based at least in part on the one or more additional antenna ports.

26. The method of claim 17, further comprising:
identifying a set of cyclic shift values, a Walsh sequence, or both, associated with wireless communications between the UE and the base station based at least in part on the indication of the first antenna port value; and
identifying the at least one antenna port of the plurality of antenna ports in accordance with the set of cyclic shift values, the Walsh sequence, or both.

27. The method of claim 17, further comprising:
transmitting, to the UE, third control signaling indicating a second frequency domain orthogonal cover code sequence length of the plurality of frequency domain orthogonal cover code sequence lengths associated with wireless communications with the base station, the second frequency domain orthogonal cover code sequence length different from the first frequency domain orthogonal cover code sequence length;
receiving, from the base station, fourth control signaling comprising an indication of a second antenna port value of the plurality of antenna port values for wireless communications between the UE and the base station;
transmitting, to the base station, at least one additional demodulation reference signal via at least one additional antenna port of the plurality of orthogonal antenna ports identified based at least in part on the second frequency domain orthogonal cover code sequence length and the second antenna port value.

28. The method of claim 27, further comprising:
receiving, from the UE, an indication of a channel quality associated with a channel between the UE and the base station, wherein transmitting the third control signaling, transmitting the fourth control signaling, or both, is based at least in a part on receiving the indication of the channel quality.

29. An apparatus for wireless communication at a user equipment (UE), comprising:
a processor;
memory coupled with the processor; and
instructions stored in the memory and executable by the processor to cause the apparatus to:
receive, from a base station, first control signaling indicating a first frequency domain orthogonal cover code sequence length of a plurality of frequency domain orthogonal cover code sequence lengths associated with wireless 9 communications with the base station;
receive, from the base station, second control signaling comprising an indication of a first antenna port value of a plurality of antenna port values for wireless communications between the UE and the base station; and
transmit, to the base station, at least one demodulation reference signal via at least one antenna port of a plurality of orthogonal antenna ports identified based at least in part on the first frequency domain orthogonal cover code sequence length and the first antenna port value.

30. An apparatus for wireless communication at a base station, comprising:
a processor;
memory coupled with the processor; and
instructions stored in the memory and executable by the processor to cause the apparatus to:
transmit, to a user equipment (UE), first control signaling indicating a first frequency domain orthogonal cover code sequence length of a plurality of frequency domain orthogonal cover code sequence lengths associated with wireless communications with the base station;
transmit, to the UE, second control signaling comprising an indication of a first antenna port value of a plurality of antenna port values for wireless communications between the UE and the base station; and
receive, from the base station, at least one demodulation reference signal via at least one antenna port of a plurality of orthogonal antenna ports identified based at least in part on the first frequency domain orthogonal cover code sequence length and the first antenna port value.
